(19) United States
(12) Patent Application Publication
(10) Pub. No.: US 2012/0053994 A1
(43) Pub. Date: Mar. 1, 2012

(54) ORGANIZATION RESOURCE ALLOCATION BASED ON FORECASTED CHANGE OUTCOMES

(75) Inventors: John Cowan, Charlotte, NC (US); Rachel Nemecek, Charlotte, NC (US); Edward M. Dunlap, JR., Cramerton, NC (US); Charles C. Howie, Charlotte, NC (US)

(73) Assignee: Bank of America, Charlotte, NC (US)

(21) Appl. No.: 12/871,691

(22) Filed: Aug. 30, 2010

(51) Int. Cl. G06Q 10/00

(52) U.S. Cl. 705/7.38

(57) ABSTRACT

Apparatus and methods for reducing infrastructure failure rates. The apparatus and methods may compile and store data related to the physical devices and applications associated with an infrastructure change. Variables may be derived from the stored data using a range of methods and multiple variable values may be consolidated. A model may be developed based on the values and relationships of the derived variables. The model may be applied to assess the risk of a prospective infrastructure change. The risk may include an index that corresponds to the likelihood that the infrastructure change will lead to a failure. The model may predict the magnitude of a failure should the infrastructure change fail. The model may predict the expected failure impact based on the index and the failure magnitude.

### FIELD OF TECHNOLOGY

Aspects of the disclosure relate to predictive modeling. In particular, the disclosure relates to predicting the magnitude of a customer impact based on a change outcome.

### BACKGROUND

Technology executives need tools to enable objective, informed decision-making related to infrastructure change deployment. The ability to predict technology failure risk ensures that appropriate changes are made at appropriate times for maximum production stability.

Conventional assessment of risk related to infrastructure change focuses on data surrounding the infrastructure change itself rather than on historical relationships such as those between physical devices, applications and individuals involved in the infrastructure change. As a result, there is a need for risk prediction that is related to those relationships.

It would be desirable, therefore, to provide apparatus and methods to reduce infrastructure failure rates.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative event that may be analyzed in accordance with the principles of the invention;

FIG. 2 shows illustrative information in accordance with the principles of the invention;

FIG. 3 shows illustrative apparatus in accordance with the principles of the invention;

FIG. 4 shows an illustrative process in accordance with the principles of the invention;

FIG. 5 shows another illustrative process in accordance with the principles of the invention;

FIG. 6 shows still another illustrative process in accordance with the principles of the invention;

FIG. 7 shows yet another illustrative process in accordance with the principles of the invention;

FIG. 8 shows yet another illustrative process in accordance with the principles of the invention;

FIG. 9 shows yet another illustrative process in accordance with the principles of the invention;

FIG. 10 shows yet another illustrative process in accordance with the principles of the invention;

FIG. 11 shows yet another illustrative process in accordance with the principles of the invention;

FIG. 12 shows yet another illustrative process in accordance with the principles of the invention;

FIG. 13 shows yet another illustrative process in accordance with the principles of the invention;

FIG. 14 shows yet another illustrative process in accordance with the principles of the invention;

FIG. 15 shows another view of the event of FIG. 1;

FIG. 16 shows other illustrative information in accordance with the principles of the invention;

FIG. 16A shows further illustrative information in accordance with the principles of the invention;

FIG. 17 shows yet another illustrative process in accordance with the principles of the invention;

FIG. 18 shows yet another illustrative process in accordance with the principles of the invention;

FIG. 19 shows yet another illustrative process in accordance with the principles of the invention;

FIG. 20 shows yet another illustrative process in accordance with the principles of the invention;

FIG. 21 shows still further illustrative information in accordance with the principles of the invention;

FIG. 22 shows still further illustrative information in accordance with the principles of the invention;

FIG. 23 shows still further illustrative information in accordance with the principles of the invention; and

FIG. 24 shows yet another illustrative process in accordance with the principles of the invention.

### DETAILED DESCRIPTION OF THE INVENTION

Apparatus and methods for reducing infrastructure failure rates are provided. Infrastructure may include hardware, software, apparatus, processes, information, applications, programs, circuits, schedules, financial instruments, transactional systems, manufacturing equipment, construction equipment, structures, roadways, transportation systems or any other types of infrastructure.

The apparatus may include machine readable memory that is configured to store a data object. The data object may include an infrastructure change identifier, corresponding to an infrastructure change, a device identifier that identifies a device that is associated with the change, and an application identifier that identifies a program that is associated with the change.

The infrastructure change may be an addition, a new or revised deployment, replacement, repair, construction, routing, scheduling or any other suitable change.

The apparatus may include a processor. The processor may be configured to provide an index that is based on the infrastructure change identifier, the device identifier and the application identifier. The index may correspond to a predicted failure rate for the infrastructure change.

The index may be an output of a predictive model. In some embodiments, the predictive model may determine a probability of failure of the infrastructure change. The model may be based on historical information about the failures of past infrastructural changes. In some embodiments, the failure risk of a prospective infrastructure change may be predicted based on performance (success or failure) of historical infrastructure changes that have similar characteristics.

The predictive model may include independent variables that are based on infrastructure changes. The independent variables may be organized as fields of change records that are related to the infrastructure changes. The predictive model may be developed using algorithms that predict the value of a success/fail score, which may be a dependent variable. The predictive models may be trained using historical values of the success/fail score. A predictive model that “predicts” historical success/fail scores with sufficient accuracy may be deployed to predict the value of a success/fail score for a prospective change that is represented by a change record. A failure prediction for a prospective infrastructure failure may be used to take action to avoid or reduce the likelihood of failure.

The infrastructure may support activities of an enterprise. The enterprise may be a commercial enterprise, a personal enterprise, a non-profit entity, a governmental enterprise or any other suitable enterprise.

The enterprise may provide one or more products or services (“the goods”) to a customer or engage in activities associated with the customer. For example, the enterprise may provide financial services, consumer products, durable goods, construction services, shipping, transportation, social services or any other suitable goods or services.

The customer may be a business, a governmental body, a member of the public, a group, an individual or any other suitable customer.

A failure may be an event or pattern of events (the “event”) that are indicative that an enterprise infrastructure performed at a level below a desired level. For example, when the enterprise provides goods to a customer, the customer may experience the goods as having less quality than a threshold quality level. The quality level may be based on quality, quantity, availability, timing, customer service or any other suitable metric. The threshold quality level may be set by the enterprise. The threshold quality level may be set by the customer. The event may be judged a failure by the enterprise. The event may be judged a failure by the customer.

The probability of failure may be constructed as a percent likelihood that the infrastructure change will fail on or after deployment. The model may determine the risk percentile of an infrastructure change. For example, the predictive model may describe where the change would fall in the overall risk distribution of historical change for the enterprise.

In some embodiments, the model may also produce one or more factor correlations for the infrastructure change. If the infrastructure change is a failure, the model may identify factors that correlate positively with the failure. For example, when an infrastructure change crosses lines of business and involves hardware that is updated infrequently, the crossing of lines of business and the infrequently updated hardware may both be correlated factors. The correlation factors may help the enterprise make informed decisions regarding implementing infrastructure changes.

The data object may correspond to a change record. The change record may be an information structure that identifies the infrastructure change. The change record may include fields. The change record may include one or more change fields that correspond to the nature and scope of the change. For example, the change fields may include a change identifier, a change date, a proposed change date, a change description (e.g., upgrade router), a change scope (all routers purchased before 1998) and other suitable change fields. The change record may include data structures that are distributed across different devices. The change record may include data structures that are distributed across different processes.

In some embodiments, the change record may correspond to an observation or row in a data analysis workbench data set. The change fields may correspond to columns or “variables” in the data set.

The change record may include the success/fail score. The success/fail score may be continuously, discretely, categorically or binary valued variable. The change record may be one of a “universe” of change records that relate to historical changes in the enterprise infrastructure. The universe may be used to determine historical relationships between change factors and failures. The historical relationships may be used to predict future failures of prospective changes based on the historical relationships.

The change record may include one or more change element fields. Each change element field may correspond to an infrastructural element that has an operational or organizational association (“an operational association”) with the change. The operational association may be a physical association, a logical association, a virtual association, a causal association, an economic association, financial association or any other suitable association. For example, when an infrastructure change includes replacement of a router, change elements may include one or more upstream or downstream devices in communication with the router. The change elements may include applications on the devices. Each change element may be identified in a corresponding change element field in the change record. For example, each element may have a corresponding unique change element identifier.

Change element fields may include any suitable information based on a change element. For example, a change record may include one change element field that identifies a change element, such as a router, and a series of change element fields that correspond to attributes of the change element, like router driver, firmware, bandwidth, transmitter power and the like.

Change elements may include enterprise organizational segments. For example, an organization segment such as a project team may be a change element. The project team may be an approving organizational segment. The approving organizational segment may have responsibility for approving the infrastructural change, whether at proposal stage, performance stage or completion stage. In some embodiments, the data object may include an approver identifier.

The project team may be an implementing team. The implementing team may by a team that performs some or all of the change. The data object may include an identifier that identifies the implementing team.

The device may be a change element.

The program may be a change element.

The processor may be configured to incorporate the element identifiers into the change record. In some embodiments, the processor may be configured to generate one or more supplemental values based on a change element. A supplemental value may be a variable that is derived from one or more attributes of the change elements (a “derived variable”). For example, the supplemental value for a router may be a mean time between failures for the router.

The change record may also include one or more operational associations of the elements. In some embodiments, for example, an operational association may logically link a first change element to a second change element when a change in the first change element does or may cause a change in the likelihood of failure of the second change element. The change itself may be viewed as a change element that has an operational association with one or more other change elements. The change itself may affect downstream change elements, such as devices or programs that depend on the change. The change itself may be affected by upstream change elements, such as an implementing team or an approving team. The operational associations may be stored such that the processor can map the operational associations between the change elements.

The processor may be configured to calculate a failure rate by device, the failure rate determined by dividing the number of failed infrastructure changes associated with the device by the total number of infrastructure changes associated with the device.

Where the device and the program, among other elements, are elements of the change, if the change is a failure, the processor may be configured to identify one or more of the elements that are positively correlated with the failure.

The apparatus and methods may acquire data from multiple sources of infrastructure information. The infrastructure information may be consolidated in a centralized database.

The infrastructure information may include physical device data that may include attributes of the physical items that may affect or be affected by the change. Examples of physical device data include the type of configurable item (i.e. server, network, etc.), the type of and number of CPUs in the configurable item, the operating system, the manager of the item, and any other relevant data.

The infrastructure information may include application data that relates to includes providing information on all the applications supported by or housed on the physical devices impacted by the change. Examples of application data may include a peak number of users on each application, an average transaction volume of each system, whether the application is internally or externally facing, a number of downstream applications dependent on the impacted applications, code inspection and review procedures for an application and any other relevant application data.

The infrastructure information may include change data providing attributes of the change itself, such as a priority, a level of process rigor, turnaround time, planned duration, and any other relevant data.

The infrastructure information may include incident data, providing information on historical failures caused by the change, such as failure duration, timing, root cause, magnitude, and any other relevant data.

The infrastructure information may include data related to approving organization describing attributes of the organization impacted by the change. Such data may include an organization name, a rate of successful approvals, and any other relevant data.

The infrastructure information may also include data related to an implementing team describing attributes of the team. Such data may include the team name and hierarchy, an overall success rate regarding performance at performing the particular type of change, overall success rate at performing change on the implicated physical devices, and any other relevant data.

Derived variables may be based on any suitable logic or algorithm. For example, variables may be created by looking at behaviors across a time series to create a performance metric. Derived variables may be created by aggregating like “levels” of data based on functional or statistical similarity. (A level is an interval on a spectrum of data values. For example, for a continuous variable, a level may be a numerical range. For a categorical variable, a level may be a category. For an ordinal variable, a level may be an order. For cluster-based variables, the level may be a cluster parameter, statistic, identifier or the like.)

Derived variables may use a number of incoming pieces of data to derive a new piece of information.

When a change is operationally associated with a large number of change elements, a derived variable may be formulated and evaluated to represent the failure risk of the large number of change elements. In some instances, the large number of change elements may have in the aggregate a wide spectrum and large number of attribute values (levels). For example, a router change may be operationally associated with 1,000 receivers. The receivers may have mean time between failures that range from 3 months to 60 months. In terms of months, there may be 57 levels of mean time between failures.

Using the change record universe, the levels may be grouped into a smaller number of representative levels for computational or analytical simplicity. For example, the levels may be simplified using one or more tree models or clustering algorithms.

Indicator variables may be created for variables where multiple values are provided and, for functional reasons, one value cannot be selected. A binary variable may be created for each possible value of the data element and the presence of that value is indicated on each individual change. For example, a router change for a change record identified as Change No. 456789 may be operationally associated with 1,500 wireless communication devices. The change record universe may include 4,000 wireless communication devices. Among the 4,000 communication devices there may be groups of 1-, 2-, 3- , . . . , and N-channel devices (n=1 to N). Certain groups, corresponding to different values of n, may be identified as being important for failure prediction. Those groups may be selected. Derived binary variables for the selected groups may be added to the change record. For example, groups corresponding to n=2, 4, 6, 24 may be selected. Derived variables “2,” “4,” “6” and “24” may be added to change record 456789. The derived variables “2,” “∝,” “6” and “24” would then be evaluated as “0” or “1” (or the equivalent) based on the inclusion or exclusion of 2-, 4-, 6- and 24-channel wireless communication devices among the 1,500 wireless communication devices in the change.

Changes recorded in the central database may be classified as a success or failure, based on one or more tests. The classification may be recorded and applied in the creation of the derived variables.

A derived variable may be created by calculating the failure rate by physical device. Accordingly, the variable may describe how often changes performed on a particular physical device have failed.

Another derived variable may be created by calculating failure rate by implementing team. Such a variable may describe how often changes performed by a particular implementing team have failed. Rates may be calculated based on each type of change performed.

Another derived variable may be created by collapsing values of distinct approving organizations using clustering. A set of approving organization data may be clustered and then correlated against failure rate to create a smaller set of failure rates by approving organization.

Another derived variable may be created by calculating the number of physical devices impacted by a change.

Another derived variable may be created by calculating the average changes per physical device over a defined time period.

Additional derived variables may be created based on date and time attributes of the change, such as the date, time, hour and month a change occurs.

For some of the derived variables, a 1:many relationship is created between an individual change and many related variable values. Values for each variable may be selected or collapsed based on a variety of methods, including calculation of greatest risk, summation, indicator variables, and consolidation logic. After all the 1:many relationships have been resolved, the data may be compiled into a viewable display that provides one line per change with the calculated values for each variable.

In the calculation of greatest risk method for collapsing variable values, each possible variable value can be evaluated against success or failure over time. In the case of categorical variables, the value which presents greatest risk can be determined. Each variable value can be tested individually against all change failure and its risk level can be determined. In the case of interval variables, the direction (i.e. higher or lower) which presents greatest risk can be determined using regression, or by some other suitable calculation. Of all the values associated with the change, the one with the greatest calculated risk can be selected and assigned.

In the summation method for collapsing variable values, certain types of interval variables can be matched and summed to produce a total for the change.

In the indicator variables method for collapsing variable values, unique binary variables may be created for each distinct value of the variable. The range of data encoded in the binary variables preferably preserves all the data from the multiple variable values, while allowing a 1:1 relationship between each variable and the change. For example, for a change potentially involving eight devices, the combination of devices involved may be significant. Eight binary variables may be created, each corresponding to a single device. In this way the relationship between change failure and the interactions between the devices is captured in the change record.

The consolidation logic method for collapsing variable values, preferably uses AND/OR logic to group values for a given variable. Under AND logic, all the specified values should preferably be present in order to create a change record classified as true. For example, if 250 different elements are all above a predetermined threshold value, the record is classified as true. If not, the record is classified as false.

Using OR logic to collapse the variable values, at least one of the specified values should be present to obtain a true classification. For example, if the change record incorporates 350 applications and two are known to cause failure, OR logic may be applied to test whether any variable values incorporate those two failed applications. If any of the specified values are present, the record is classified as true. When no specified values are present, it is classified as false.

After the variable values have been determined, the data may be imputed and transformed to render it more suitable for effective modeling. Missing values may be imputed using standard methods such as individual decision trees, means or constants, or any other suitable method, as applicable for each variable. Missing values for categorical variables may be replaced using levels specified by the modeler, or using any other suitable method. Interval variables presenting with a highly skewed distribution may be logarithmically transformed to minimize the effect of outliers or adjusted by any other suitable method.

Models may be created using regression, neural networks, and decision trees or any other suitable method. Models may be tested against historical data. Data mining software may be used to select the model with the greatest predictive capability, based on the optimization of a particular statistic, such as lift, average squared error or any other suitable statistic.

In applying the model prospectively, the variables may be mapped, derived, and collapsed as described above. The values may be entered into the model to calculate a percent failure rate for a proposed infrastructure change.

In some embodiments, the apparatus may include machine memory storing a first entity segment identifier, a second entity segment identifier, an infrastructure change identifier that identifies an historic infrastructure change, and a failure characteristic corresponding to the historic infrastructure change, each addressable as a different component of a data object. The data object may correspond to a change record or a portion of a change record.

The first entity segment identifier may correspond to an approving entity that includes one or more approving organizations associated with the infrastructure change.

The second entity segment identifier may correspond to an implementing team that is associated with the infrastructure change.

The apparatus may also include an input module that is configured to receive a prospective infrastructure change record.

The apparatus may also include a processor that is configured to provide an index based on the prospective infrastructure change record and the data object.

The approving entity and the implementing team may be parts of a group of elements, each with an organizational association with the infrastructure change. Each element may also have an element identifier. The processor may be configured to include any elements from this group in the data object. The data object may also include the organizational associations of the elements.

The processor may be configured to calculate a failure rate for an approving entity associated with a number of changes. The failure rate may be calculated by dividing the number of failed changes associated with the approving organization by the total number of changes associated with the approving organization.

Where there is a group of approving entities, each associated with a respective failure rate, the processor may be configured to identify two or more clusters of approving entities and correlate the clusters with the failure rates. The approving entities are clustered using a self organizing map.

The processor may be configured to calculate a failure rate for an implementing team associated with a number of changes. The failure rate may be calculated by dividing the number of failed changes associated with the implementing team by the total number of changes associated with the implementing team.

Where the approving entity and the implementing team, among other elements, are elements of the change, if the change is a failure, the processor may be configured to identify one or more of the elements that are positively correlated with the failure.

In some embodiments, the apparatus may include machine memory storing logical links. The links may associate an infrastructure change with one or more elements of the change.

In some of those embodiments, each of the elements may have a failure risk score. The apparatus may also include a processor that is configured to determine a representative risk score. The risk score corresponds to a sum of the failure risk scores of the elements.

Each of the elements may have an order n, n=1, 2, 3, . . . , based on logical proximity to the infrastructure change. The logical links may form logical chains that extend from the infrastructure change to the elements. Each link between elements may extend from a higher order element to a lower order element.

Each logical chain may have a chain risk score. The chain risk score may be based on the multiplicative product of the failure risk scores of the elements of the chain. The sum of the failure risk scores of the elements may include the sum of the chain risk scores.

One or more of the elements of the infrastructure change may be a device associated with the change. Other elements of the infrastructure change may be approving organizations associated with the change. Other elements of the infrastructure change may be an implementing team associated with the change.

The processor may be configured to provide an index that is based on the representative failure risk score. The index may correspond to a predicted failure rate for the infrastructure change.

Where the infrastructure change is classified as a failure, the processor may be configured to identify one or more of the elements that are associated with the change that are positively correlated with the failure.

In some embodiments, the apparatus may include machine memory storing an infrastructure change record. The change record may correspond to an infrastructure change that includes two or more change elements.

The apparatus may also include a processor that is configured to enter a result of a Boolean operation on one or more of the change elements into the change record.

A Boolean operation on change elements may be an intersection or a union between the change elements and an element characteristic. Examples such operations may include an intersection of the change elements and a device characteristic, an intersection of the elements and an organizational segment characteristic, and a union of the elements and a program characteristic.

The Boolean operation may be an intersection of a first element characteristic and a second element attribute. Examples of element characteristics may include device characteristics, program characteristics, and organizational segment characteristics.

In some embodiments, the apparatus may include machine memory that stores a first array of infrastructure change element attributes and a second array of change element tallies. Each tally may correspond to one of the change element attributes and include a number of change elements that have the attribute. The first and second arrays may be based on a plurality of historical change records. The apparatus and methods may include a processor that is configured to: (1) select one or more of the change element attributes based on the corresponding tallies; (2) select one of the plurality of historical change records; and (3) enter into the selected change record a Boolean indicator corresponding to each of the selected change element attributes.

In some embodiments, in the attributes in the first array may include device attributes. The device attribute may be a device model.

In some embodiments, the attributes in the first array may include program attributes. The program attribute may be a program version.

In some embodiments, the attributes in the first array may include organization segment attributes. The organization segment attribute may be a segment membership number.

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

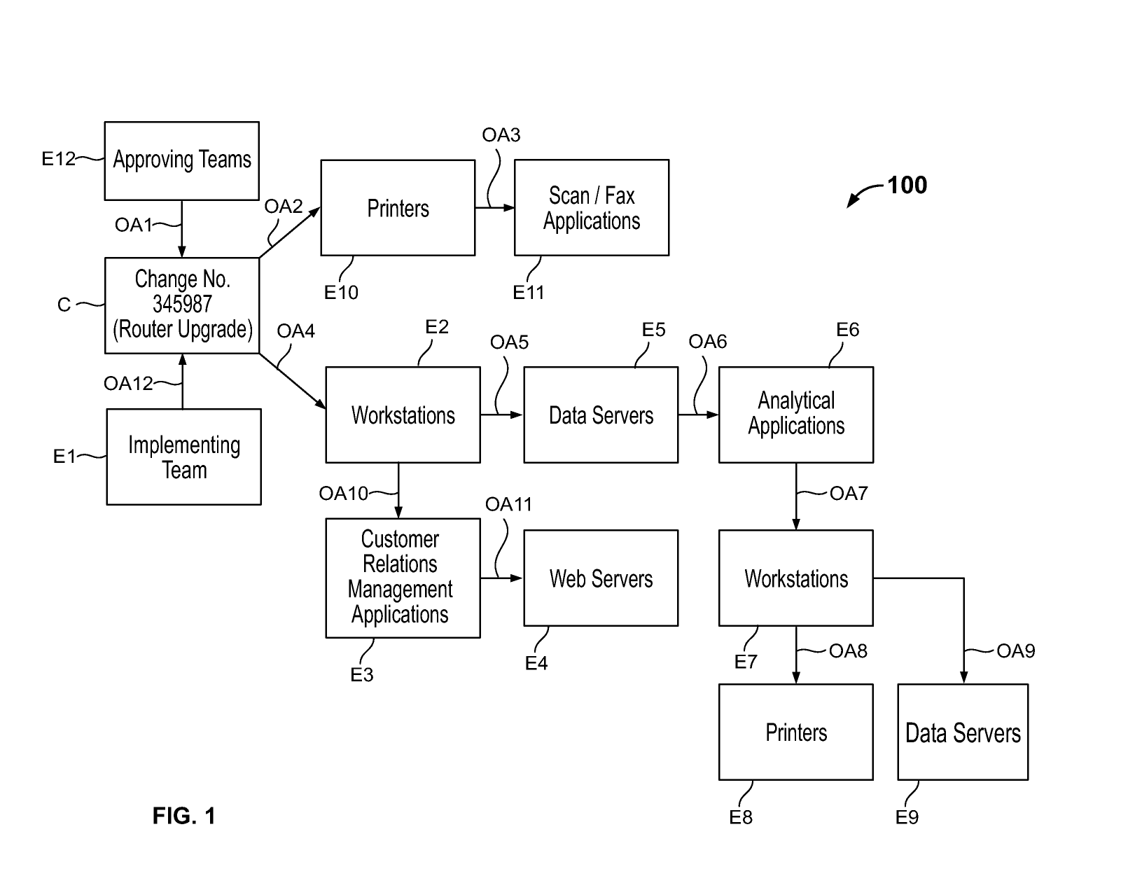

Embodiments of the invention will now be described with reference to FIGS. 1-24.

FIG. 1 shows illustrative infrastructure change map 100. Change map 100 represents change CHG and change elements E1 (an implementing team), E2 (workstations), E3 (customer relations management applications, E4 (web servers), E5 data servers, E6 (analytic applications), E7 (workstations), E8 (printers), E9 (data servers), E10 (printers), E11 (scan/fax applications) and E12 (approving team).

Change CHG is illustrative of a change in the infrastructure of an enterprise. Change CHG is illustrated as a router upgrade and is identified for illustration as Change No. 345987 of a population of changes that is associated with the enterprise. Change elements Ei (i=1 to 12) are operationally associated with change CHG. The operational associations are identified as OA1-OA12. OA1-OA12 may indicate, for a pair of operationally associated change elements, which element affects the other.

Map 100 shows changes E1 and E12 as being “upstream” of change CHG. Map 100 shows changes E2-E11 as being “downstream” of change CHG. Map 100 illustrates work stations E2 as being a single element for the sake of illustration, but work stations E2 may include any suitable number of work stations that are operationally associated with change CHG as is E2.

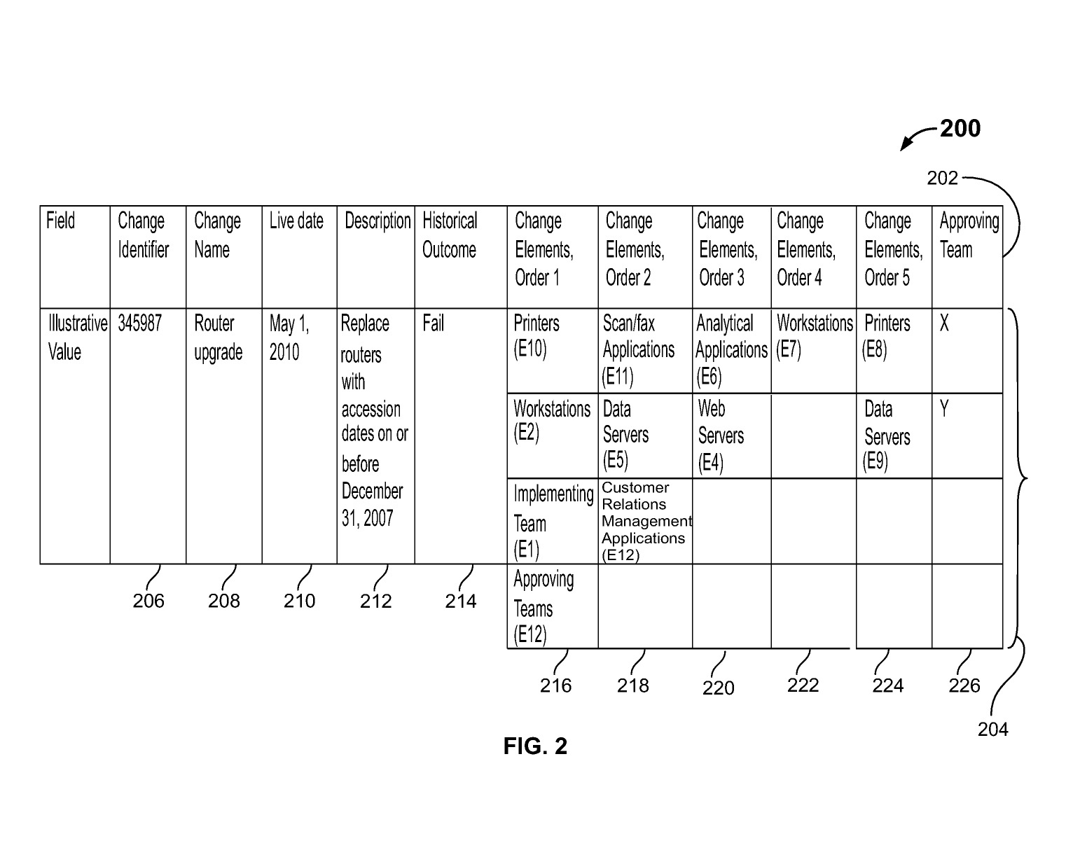

FIG. 2 shows illustrative change record 200. Illustrative change record 200 may be one of a universe of change records that is associated with the enterprise. Change record 200 may correspond to change CHG (shown in FIG. 1). Change record 200 may include fields 202. Change record 200 may include values 204 that correspond to the fields. Value 206 is change identifier 345987. Value 208 is the change name “router upgrade.” Value 210 is live date “May 1, 2010,” which is the hypothetical date that change 345987 went live. Value 212 is a plain language description of change 345987. Value 214 is an historical outcome of change 345987, which was a failure.

Value 216 is an array of first order change elements. The first order change elements of change 345987 are E10, E2, E1 and E12 (shown in FIG. 1). Each of values 216 may include one or more arrays, which may be nested. The arrays may include change element attributes. For example, printers E10 may include an array of a plurality of printers. Each of the printers in the array may be identified by serial number.

Value 218 is an array of second order change elements. The second order change elements of change 345987 are E11, E5 and E3 (shown in FIG. 1). Each of values 218 may include one or more arrays, which may be nested. The arrays may include change element attributes. For example, printers scan/fax applications may include an array of applications that drive scan and fax functions of the respective printers. Each of the printers in the array may be identified by serial number.

Value 220 is an array of third order change elements. The third order change elements of change 345987 are E6 and E4 (shown in FIG. 1). Each of values 220 may include one or more arrays, which may be nested and include change element attributes.

Value 222 is an array of fourth order change elements. The fourth order change elements of change 345987 include E10 (shown in FIG. 1). Each of values 222 may include one or more arrays, which may be nested and include change element attributes.

Value 224 is an array of fifth order change elements. The fifth order change elements of change 345987 are E8 and E9 (shown in FIG. 1). Each of values 220 may include one or more arrays, which may be nested and include change element attributes.

Value 226 is an array of approving teams. The approving teams for change 345987 are Team X and Team Y.

Change record 200 may include any suitable number of change element orders.

Change record 200 may include fields for operational associations OA1-OA12 (shown in FIG. 1, not shown in FIG. 2).

Change record 200 may be one of a universe of change records that is used to determine historical relationships between factors and failure. In predictive modeling, the relationships may be applied to a change record for a prospective change. A prospective change record may have one or more of values 204. A prospective change record may not include historical outcome 214.

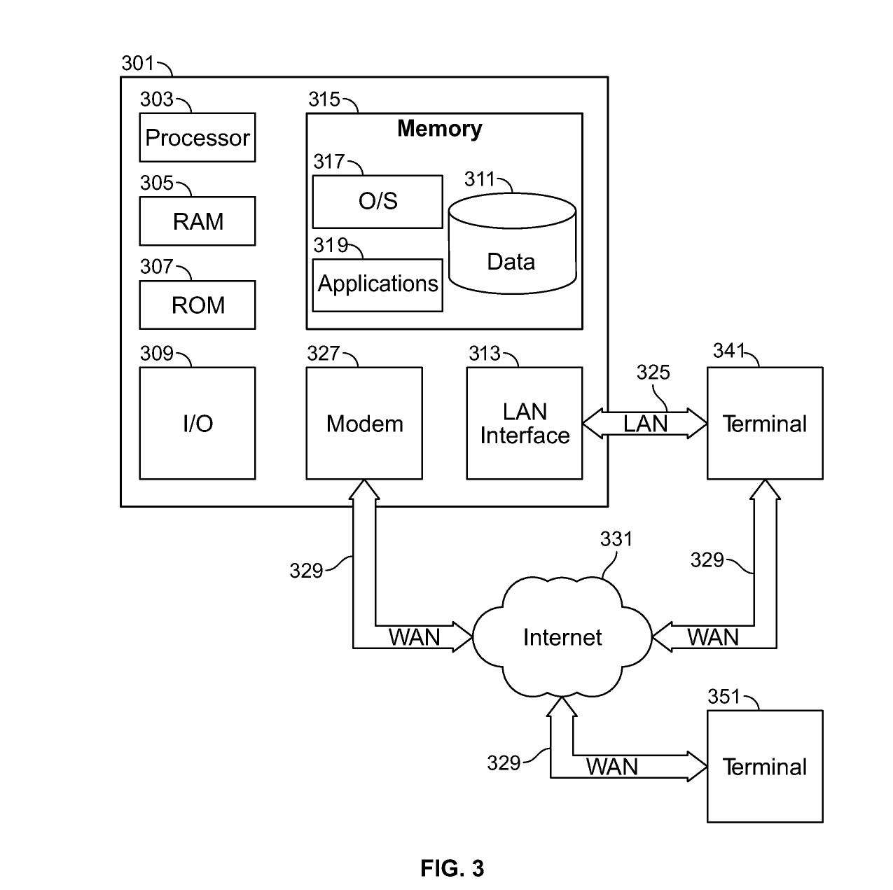

FIG. 3 is a block diagram that illustrates a generic computing device 301 (alternatively referred to herein as a “server”) that may be used according to an illustrative embodiment of the invention. The computer server 301 may have a processor 303 for controlling overall operation of the server and its associated components, including RAM 305, ROM 307, input/output module 309, and memory 315.

Input/output (“I/O”) module 309 may include a microphone, keypad, touch screen, and/or stylus through which a user of device 301 may provide input, and may also include one or more of a speaker for providing audio output and a video display device for providing textual, audiovisual and/or graphical output. Software may be stored within memory 315 and/or storage to provide instructions to processor 303 for enabling server 301 to perform various functions. For example, memory 315 may store software used by server 301, such as an operating system 317, application programs 319, and an associated database 321. Alternatively, some or all of server 301 computer executable instructions may be embodied in hardware or firmware (not shown). As described in detail below, database 321 may provide storage for infrastructure change data, values of variables, mapping data, modeling results and any other suitable information.

Server 301 may operate in a networked environment supporting connections to one or more remote computers, such as terminals 341 and 351. Terminals 341 and 351 may be personal computers or servers that include many or all of the elements described above relative to server 301. The network connections depicted in FIG. 3 include a local area network (LAN) 325 and a wide area network (WAN) 329, but may also include other networks. When used in a LAN networking environment, computer 301 is connected to LAN 325 through a network interface or adapter 323. When used in a WAN networking environment, server 301 may include a modem 327 or other means for establishing communications over WAN 329, such as Internet 331. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 319, which may be used by server 301, may include computer executable instructions for invoking user functionality related to communication, such as email, short message service (SMS), and voice input and speech recognition applications.

Computing device 301 and/or terminals 341 or 351 may be mobile terminals including various other components, such as a battery, speaker, and antennas (not shown).

Terminal 351 and/or terminal 341 may be portable devices such as a laptop, cell phone, blackberry, or any other suitable device for storing, transmitting and/or transporting relevant information.

Infrastructure change data, values of variables, mapping data, modeling results and any other suitable information may be stored in memory 315.

One or more of applications 319 may include one or more algorithms that may be used to perform the calculation of variable values, collapsing multiple variable values, model development, calculation of percent likelihood of failure and any other suitable task related to assessing the risk associated with an infrastructure change.

The one or more algorithms may include those available in a data mining workbench such as that sold under the trademark SAS ENTERPRISE MINER by SAS Institute, Inc., Cary, N.C.

The invention may be operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may be practiced in distributed computing environments where tasks are performed by remote processing devices that are linked through a communications network. In a distributed computing environment, program modules may be located in both local and remote computer storage media including memory storage devices.

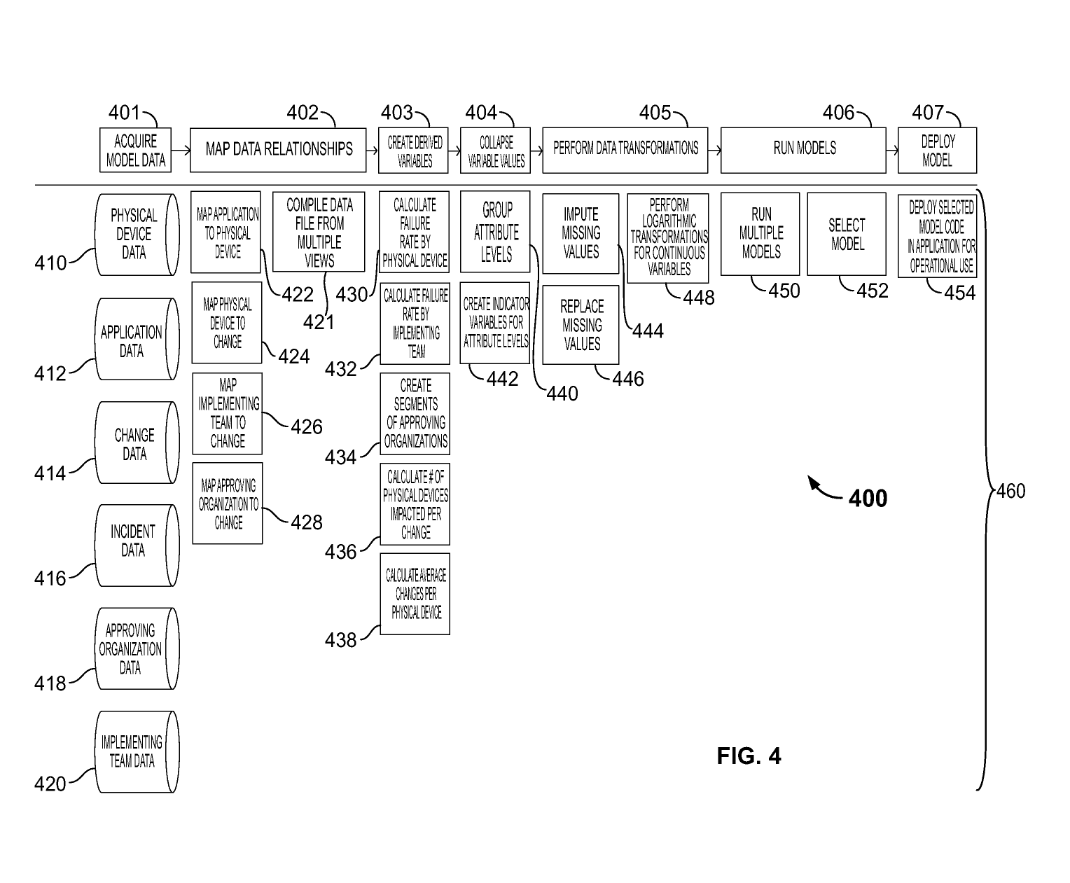

Processes in accordance with the principles of the invention may include one or more features of the process illustrated in FIGS. 4-14. For the sake of illustration, the steps of the process illustrated in FIG. 4-14 will be described as being performed by a “system.” The “system” may include one or more of the features of the apparatus that are shown in FIG. 1 and/or any other suitable device or approach. The “system” may be provided and or deployed by an entity.

FIG. 4 shows illustrative process 400 for developing an infrastructure change risk model. The steps of process 400 may include or involve resources and procedures 460.

At step 401, the system may acquire data from various sources of record (“SOM”). The data may be compiled in a central database. Representative data sources include physical device data 410, application data 412, change data 414, incident data 416, approving organization data 418 and implementing team data 420.

Table 1 shows illustrative information from the SOR.

TABLE 1
Illustrative SOR information.

| | General information | |
|---|---|---|
| SOR | type | Illustrative information |
| Physical | Attributes of the | Type of configurable item |
| Device Data | physical items that are | (server, lpar, midrange, |
| 410 | being configured or | network, etc.) |
| | affected by the change. | Type of and number of CPUs |
| | | in configurable item |
| | | Operating System |
| | | Who manages or maintains |
| | | the item |
| Application | Information regarding | Peak number of users on |
| Data 412 | applications supported | each application |
| | by or housed on | Average transaction volume |
| | physical devices that | of each system |
| | are affected by the | Whether the application is |
| | change. | internally or externally |
| | | facing |
| | | The number of downstream |
| | | applications dependent on |
| | | the impacted applications |
| | | Code inspection & review |
| | | procedures for the |
| | | application |
| Change Data | Attributes of the | Priority |
| 414 | change itself. | Level of process rigor |
| | | Turn-around time |
| | | Planned Duration |
| Incident Data | Information on | Incident duration |
| 416 | historical incidents | Timing |
| | caused by the change. | Root cause |
| | | Magnitude |
| Approving | Attributes of | Organization Name |
| Organization | organizations or | Rates of successful |
| Data 418 | organization segments | approvals |
| | within an enterprise | |
| | that approve the change | |
| | (e.g., an organization | |
| | that is affected by the | |
| | change). | |
| Implementing | Attributes of team of | Team name and hierarchy |
| Team Data 420 | individuals that | Overall success rates at |
| | execute the change. | performing the particular |
| | | type of change |
| | | Overall success rates at |
| | | performing change on |
| | | particular physical devices |

At step 402, the system may compile a data file from multiple views (421), each containing a different set of related data. The relationships among the data may be mapped. (See, for example, illustrative map 100 (shown in FIG. 1).) For example, a physical device may support many different applications, and many physical devices may be implicated in a single change. Illustrative mappings include mapping applications to physical devices 422, mapping physical devices to changes 424, mapping implementing teams to changes 426, and mapping approving organizations to changes 428. Mapping often creates a “many-to-one” relationship between a change and corresponding change elements.

At step 403, the system may create from the data one or more derived variables. A derived variable may be used to augment the change record or substitute for other information in the change record. The derived variable may be included in the change record as a change element attribute (e.g., mean time between failures for an RF receiver). The derived variable may be included in the change record as a change element (e.g., an organization cluster that is mapped as an approving organization).

A derived variable may be based on performance of a change element over time. A derived variable may aggregate like data based on either functional or statistical similarity to reduce data complexity. A derived variable may be based on two or more data points from the change record or SOR (see step 401).

Representative derived variables include failure rate by physical device 430, failure rate by implementing team 432, segments of approving organizations 434, number of physical devices impacted per change 436 and average changes per physical device 438.

Table 2 shows illustrative derived variables.

TABLE 2
Illustrative derived variables.

| Illustrative | |
|---|---|
| derived variable | General description |
| Failure Rate by | Temporal frequency of failure of changes that were |
| Physical Device | performed on or affected a physical device |
| (430) | |
| Failure Rate by | Temporal frequency of failure of changes performed |
| Implementing Team | by an implementing team. |
| (432) | |
| Approving | A clustering technique, such as a self-organizing |
| Organization | map (“SOM”) may be used to reduce complexity of |
| segment (434) | approving organization attributes and render a |
| | number of organization “segments” having like |
| | members. |
| Number of | Based on a change map, such as map 100 (shown in |
| Physical Devices | FIG. 1) |
| affected by | |
| Change (436) | |
| Calculate Average | Average number of changes per defined time period |
| Changes per | performed on a physical device. |
| Physical Device | |
| (438) | |

Whereas the derived variables listed in Table 2 are described in connection with devices and enterprise organizations, the derived variables may be used in the context of any suitable change element, such as an application, or any suitable change factor, such as a combination of change elements or a circumstance, such as geographic location or weather.

Failure rates for a change element may be calculated on the basis of all changes that involve the change element. Failure rates for a change element may be calculated on the basis of one or more types of changes. For example, different failure rates may be derived for different kinds of changes (e.g., upgrade, replacement, new operating system, new class of user, different throughput, etc.).

Approving organizations may have many attributes. The attributes may include, for example, bureaucratic echelon, breadth of authority, affiliation with lines of business, affiliation with more senior management, length of charter, inception of charter, membership size, individual members, individual member tenure, individual member seniority level, individual member experience level, individual member area of expertise, etc. The large number of attributes may be aggregated into a smaller number of clusters, each having members that have like attributes.

At step 404, the system may reduce the number of variable values by selecting from multiple values or collapsing multiple values onto one value or a small number of values. Representative methods include grouping attribute levels 440 and creating indicator variables for attribute levels 442. Many-to-one relationships between changes and corresponding elements may be collapsed into 1:1 or 1:P relationships, where P is a suitable number.

Table 3 shows illustrative multi-valued-variable selection or collapse methods.

TABLE 3
Illustrative multi-valued-variable selection or collapse methods.

| Selection or | |
|---|---|
| collapse method | General description |
| Calculation of | Of values mapped to a change, the one with the |
| greatest risk | greatest calculated risk is selected for the |
| | change. |
| Summation | Values that are mapped to a change are summed to |
| | produce a total for the change. |
| Indicator | Operationally significant levels of a universe-wide |
| variables | variables are identified. The identified levels |
| | are defined as binary variables. The presence of |
| | such a level in a change record is expressed as a |
| | “YES” in the appropriate binary variable. The |
| | absence of such a level in the change record is |
| | expressed as a “NO” in that binary variable. |
| Consolidation | A flag variable is created to indicate if ANY |
| Logic | matched value is present in a change record or if |
| | NO matched value is present in a change record. |

At step 405, the system may perform data transformations. A data transformation may be performed to conform change records to a format or scale that improves computational effectiveness. In some regression or neural network models, missing values in change records are not permitted. Representative transformations include imputing missing values 444, replacing missing values 446 and performing logarithmic transformations for continuous variables 448. Logarithmic transformations may reduce the affect of outliers on subsequent modeling steps.

Table 4 shows illustrative data transformation methods.

TABLE 4
Illustrative data transformation methods.

| Data | |
|---|---|
| transformation | |
| method | General description |
| Impute Missing | Missing values may be imputed using standard |
| Values | methods such as individual decision trees, |
| | interpolation, averaging, arbitrary constants, as |
| | appropriate for each variable. |
| Replace Missing | A missing value may be replaced by a user-selected |
| Values | value. |
| Perform | Numerical variables that have a highly skewed |
| Logarithmic | distribution may be logarithmically transformed. |
| Transformations | |
| on Continuous | |
| Variables | |

At step 406, the workbench may be used to develop one or more models. The models may be based on any suitable analytical approach. The analytical approaches may include, for example, clustering and self-organizing maps, market basket analysis, sequence and web path analysis, linear and logistic regression, decision trees, gradient boosting, neural networks, least squares regression, multi-stage modeling and other suitable approaches. In some embodiments, the analytical approaches may include dimension reduction techniques such as, e.g., variable selection, LARS (Least Angle Regression) variable selection, principal components, variable clustering, time series analysis and other suitable dimension reduction techniques.

Predictive models may be tested (450) using historical data. The models may be run using the workbench and may be based on regression (stepwise, backward, etc.), neural networks and decision trees or other suitable methods.

In some embodiments, a suite of predictive models may be run against a set of historical changes (representing, for example, approximately 1.5 years of infrastructure change data). A model may then be selected (452) based on any suitable subjective or objective criterion or criteria. For example, the criterion or criteria may be based on validation statistics such as lift, average squared error, or other suitable statistics.

At step 407, a selected model may be deployed to predict failure of a prospective infrastructure change. The model can be deployed with code 454 that receives as input a prospective change record. The code may include instructions for executing steps such as 401 through 405.

In some embodiments, the selected model may be executed on a periodic basis, or from time to time, on prospective infrastructure change records. The system may add to each prospective change record a likelihood or probability of failure. Multiple prospective changes may be stacked ranked based on likelihood or probability of failure from highest to lowest risk. The highest risk changes are sent to an operations team that actively engages the appropriate implementation team or teams to address the risks identified.

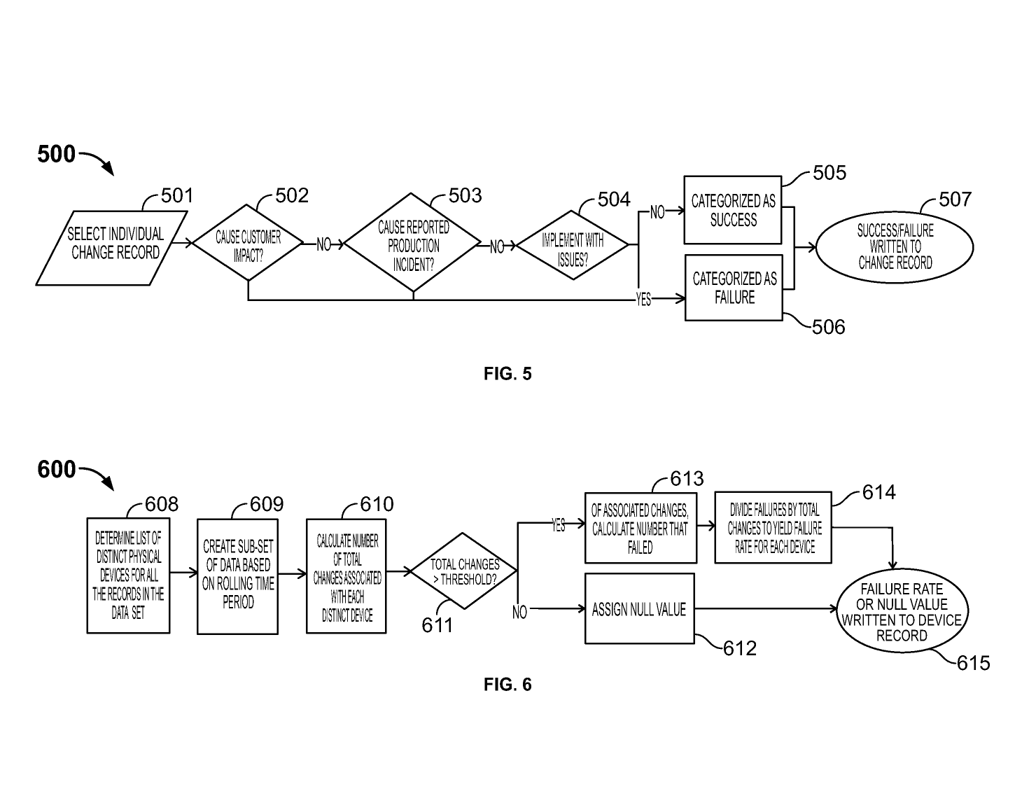

FIG. 5 shows illustrative process 500 for evaluating a historical outcome field such as historical outcome field 214 (shown in FIG. 2) in a change record.

At step 501, the system selects an individual change record from the universe of enterprise change records. At step 502, the system (or a system user or other individual) determines whether the infrastructure change corresponding to the change record caused a customer incident. In some embodiments, the customer incident may be an event that resulted in a problem, inconvenience, or service level deficiency for an enterprise customer. If at step 502, the infrastructure change is determined to have caused a customer incident, process 500 continues at step 506. At step 506, the system categorizes the infrastructure change as a failure (as it did, hypothetically, for the change in FIG. 2). Process 500 then continues at step 507. At step 507, the system writes the failure categorization from step 506 to the change record.

If at step 502, the infrastructure change was determined not to have caused a customer incident, process 500 continues at step 503. At step 503, it is determined whether the infrastructure change resulted in a reported production incident. In some embodiments, a production incident may be an identified malfunction that did not cause a customer incident. If at step 503 it is determined that a production incident occurred, process 500 continues at step 506 and proceeds as discussed above.

If at step 503 it is determined that a production incident did not occur, process 500 continues at step 504. At step 504, it is determined whether the infrastructure change was implemented with issues. In some embodiments, an infrastructure change that was implemented with issues is an infrastructure change that was corrected before or upon deployment and did not yet lead to customer incident or a production incident. If at step 504 it is determined that the infrastructure change was implemented with issues, process 500 continues at step 506 and proceeds as discussed above.

If at step 504, it is determined that the infrastructure change was not implemented with issues, process 500 continues at step 505. At step 505, the infrastructure change is categorized as a success. At step 507, the system writes the success categorization from step 506 to the change record.

FIG. 6 shows illustrative process 600 for determining a failure rate for a change element such as a physical device. Process 600 may correspond to procedure 430 of process 400 (shown in FIG. 4). At step 608, the system may create a list of distinct physical devices associated with the change records in the enterprise universe. The list may include a device record for each distinct device. The device record may include infrastructure change information for infrastructure changes that are operationally associated with the devices. The infrastructure change information may include infrastructure change dates.

At step 609, the system may partition the list into time periods so that infrastructure changes during a distinct time period can be analyzed for each device. At step 610, the system calculates a total number of changes that are associated with each distinct device. At step 611, the system determines whether the total number of changes exceeds a selected threshold.

If at step 611 the total number of changes does not exceed the selected threshold, process 600 continues at step 612. At step 612, the system assigns a null value to the device record. At step 615, the system writes the null value to the device record.

If at step 611 the total number changes exceeds the selected threshold, process 600 continues at step 613. At step 613, the system calculates the number of the total changes that are failed changes. At step 614, the system divides the number of failed changes by the number of total changes for the device to arrive at a failure rate. The system may calculate failure rates for each device for different time periods using the time-partition described in connection with step 609. At step 615, the system writes the failure rate or rates, if time-partitioned, to the device record.

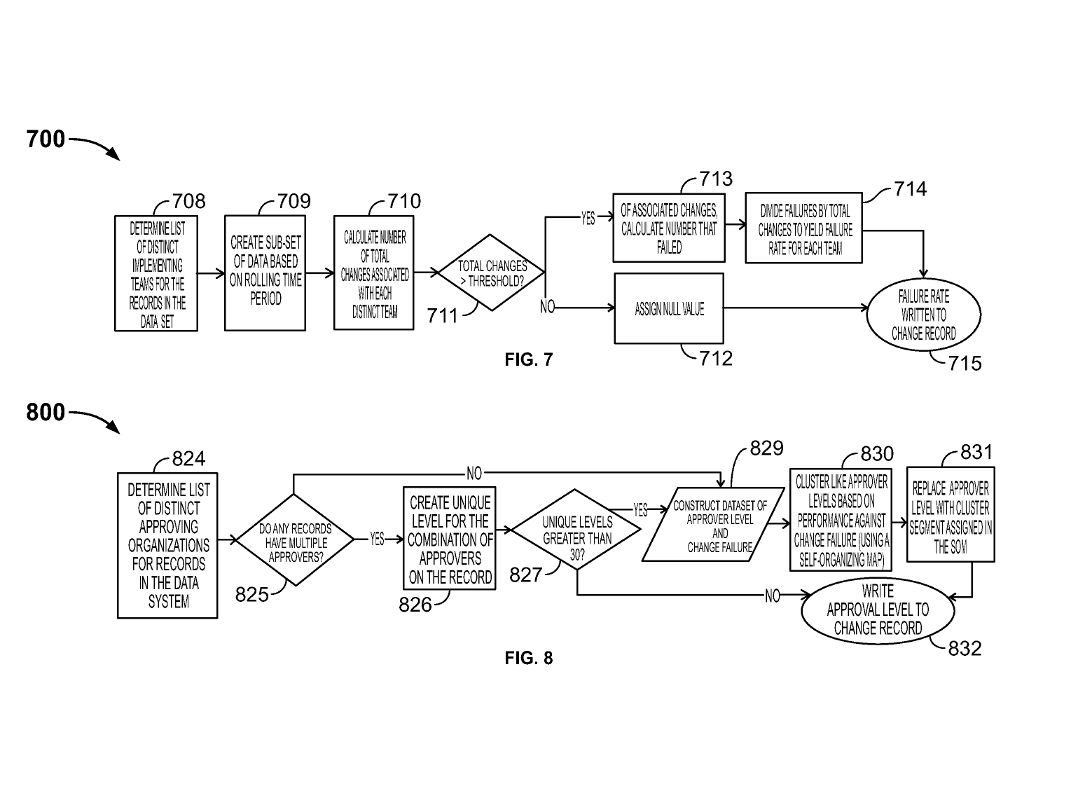

FIG. 7 shows illustrative process 700 for determining a failure rate for a change element such as a physical implementing team. Process 700 may correspond to procedure 432 of process 400 (shown in FIG. 4). At step 708, the system may create a list of distinct implementing teams associated with the change records in the enterprise universe. The list may include an implementing team record for each distinct implementing team. The implementing team record may include infrastructure change information for infrastructure changes that are operationally associated with the implementing teams. The infrastructure change information may include infrastructure change dates.

At step 709, the system may partition the list into time periods so that infrastructure changes during a distinct time period can be analyzed for each implementing team. At step 710, the system calculates a total number of changes that are associated with each distinct implementing team. At step 711, the system determines whether the total number of changes exceeds a selected threshold.

If at step 711 the total number of changes does not exceed the selected threshold, process 700 continues at step 712. At step 712, the system assigns a null value to the implementing team record. At step 715, the system writes the null value to the implementing team record.

If at step 711 the total number changes exceeds the selected threshold, process 700 continues at step 713. At step 713, the system calculates the number of the total changes that are failed changes. At step 714, the system divides the number of failed changes by the number of total changes for the implementing team to arrive at a failure rate. The system may calculate failure rates for each implementing team for different time periods using the time-partition described in connection with step 709. At step 715, the system writes the failure rate or rates, if time-partitioned, to the implementing team record.

FIG. 8 shows illustrative process 800 for identifying segments of approving organizations and associating the segments with success/failure scores for inclusion in a change record. Process 800 may correspond to procedure 434 of process 400 (shown in FIG. 4). At step 824, the system may compile a list of distinct approving organizations for the change records in the enterprise change record universe. At step 825, the system may identify change records corresponding to infrastructure changes that are operationally associated with multiple approving organizations. For example, when the enterprise is a financial institution, an e-commerce team and a bank card team may both have approving responsibility for an infrastructure change related to authentication of on-line credit card transactions.

At step 826, the system may create a unique level for each of any combinations of multiple approvers in the change records. For example, the system will add the level, “E-COMMERCE TEAM+BANK CARD TEAM” to the list of distinct approving organizations. At step 827, the number of unique levels are analyzed to see if they exceed a threshold number such as 30.

If at step 827 the number of unique levels not greater than 30, process 800 continues at step 832. At step 832, the system includes the actual approving organization or combination of organizations in the change record. Each approving organization or combination of approving organizations may have a historical success/failure score based on historical performance. The historical success/failure score may be included in the change record for predictive modeling.

If at step 827, the number of unique levels is greater than 30, process 800 continues at step 829. At step 829, the system may construct a dataset of approving organization levels (each level including an approving organization or combination of approving organizations) and corresponding success/failure scores based on historical performance. At step 830, the system may cluster the approving organization levels based on any suitable approving organization attribute or attributes. For example, the system may cluster the levels based on number of changes assigned to the level (i.e., approving organization or combination of approving organizations), frequency of assignment of changes, change lifetime metrics (mean length of time between change process inception and final approval, maximum length of time between change process inception and final approval, minimum length of time between change process inception and final approval, e.g.), presence of extenuating circumstances and any other suitable attributes. The system may use success/failure scores of the levels as a clustering dimension. Thus, each cluster may have a cluster-based effective success/failure score. The system may constrain the total number of clusters to be less than the total number of unique approving organization levels. The system may assign to each change record the approving organization level cluster that most closely matches the actual approving organization level of the change record. The system may use a self-organizing map to perform the assignment.

At step 831, the system replaces the actual approving organization levels with corresponding cluster-based approving organization levels. At step 832, cluster-based approving organization levels, along with corresponding effective success/failure scores, are written into the change records.

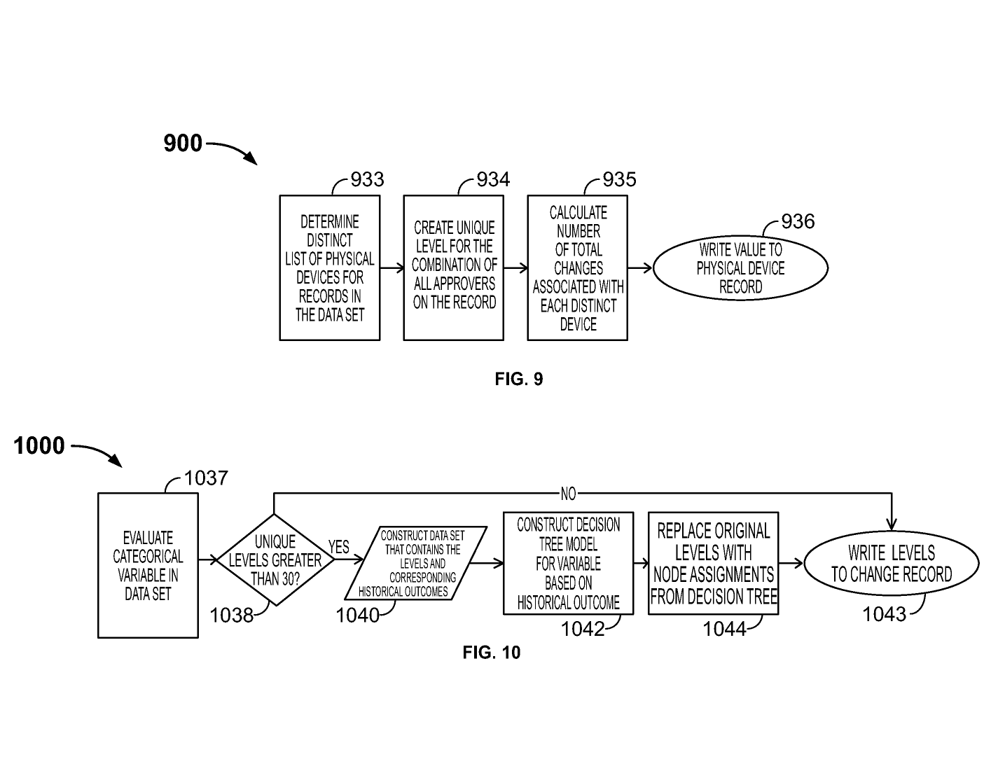

FIG. 9 shows illustrative process 900 for calculating an average number of changes for a change element such as a physical device. Process 900 may correspond to procedure 438 of process 400 (shown in FIG. 4). At step 933, a list of distinct physical devices for all change records in the data set is determined. At step 934, a subset of data is created based on a rolling time period. At step 935, the total number of changes associated with each distinct device is calculated. At step 936, this data is recorded in the device record.

FIG. 10 shows illustrative process 1000 for grouping levels to consolidate independent variables. Process 1000 may correspond to procedure 440 of process 400 (shown in FIG. 4). At step 1037, the system identifies a categorical variable in the enterprise change record universe. For example, the categorical variable may be the identity of an enterprise facility that houses a change element. At step 1038, the system determines whether the categorical variable has greater than a threshold number, such as 30, of levels. For example, when an enterprise has numerous corporate offices, customer service locations and data processing centers, the enterprise may have more than 30 enterprise facilities.

If at step 1038 the system determines that the number of distinct levels (enterprise facilities, in the example) is not greater than 30, process 1000 may continue at step 1043. At step 1043, the system may write the actual levels to the corresponding change records.

If at step 1038 the system determines that the number of distinct levels is greater than 30, process 1000 continues at step 1040. At step 1040, a data set is constructed that contains the unique levels and corresponding historical outcomes, such as value 214 in change record 200 (shown in FIG. 2).

At step 1044, the system may construct a decision tree model for the categorical variable. The decision tree model may be constrained by the historical outcomes. At step 1042, the system may identify nodes in the decision tree and map each of the categorical variable levels (e.g., enterprise facility) to a decision tree node. The system may select a section of the decision tree that includes a number of nodes that is smaller than the number of categorical variable levels. At step 1044, the system may replace each of the original categorical variable levels with a decision tree node. Each node has a corresponding effective historical success/failure score. Thus, the system may effectively reduce the number of levels in the categorical variable. At step 1043, the node-assignment levels, along with corresponding effective historical success/failure scores are written into the change records.

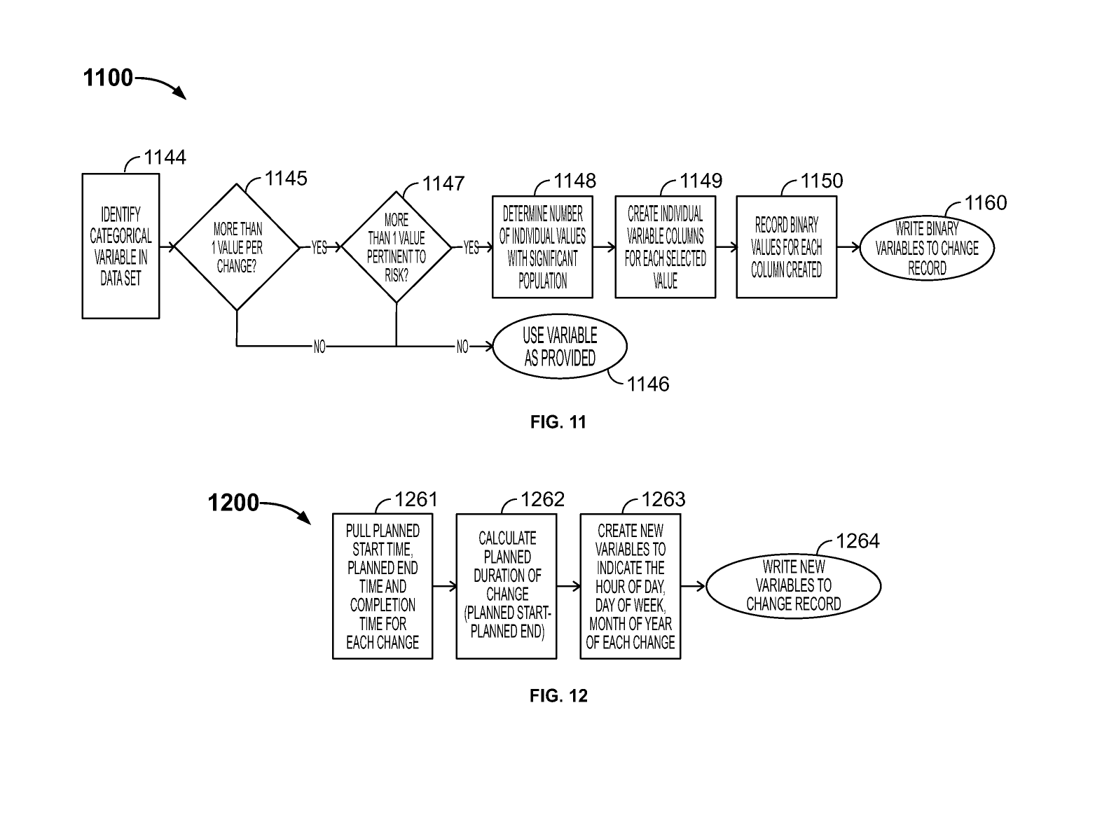

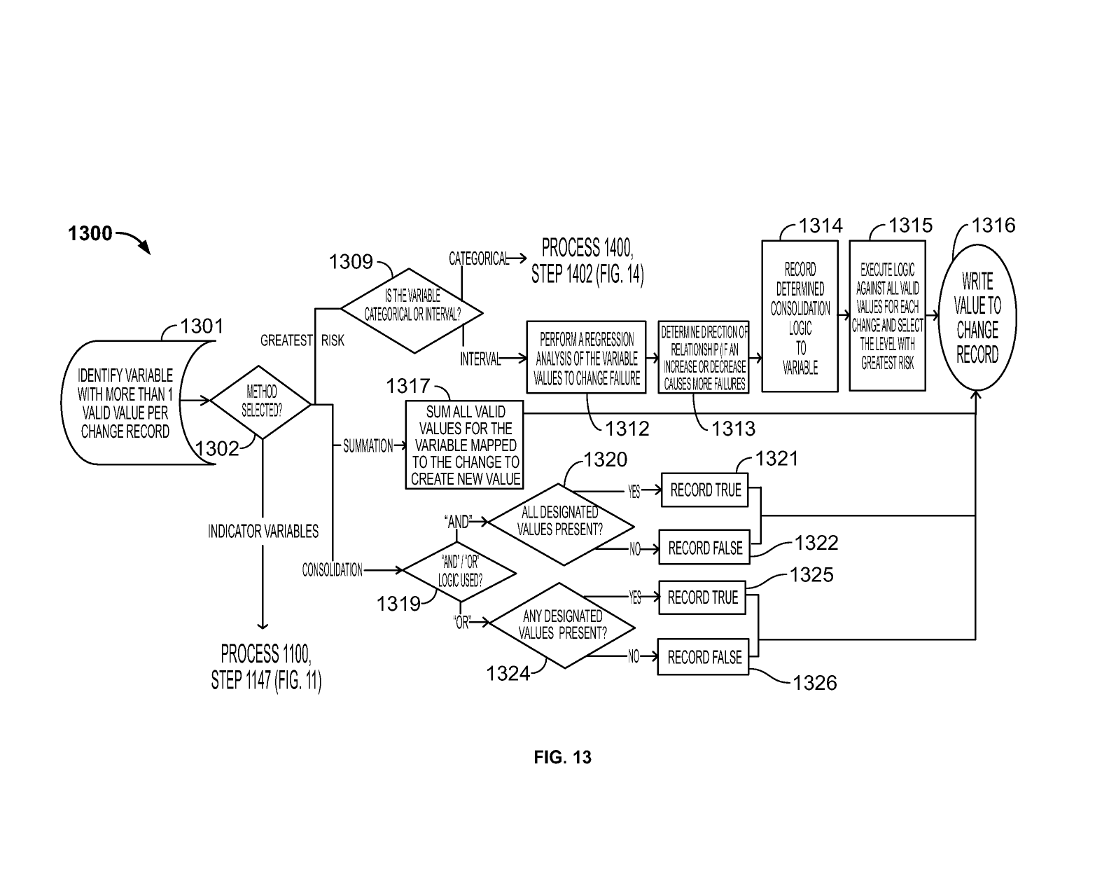

FIG. 11 shows illustrative process 1100 for creating indicator variables from a categorical variable. Process 1100 may correspond to procedure 442 of process 400 (shown in FIG. 4). At step 1144, the system may identify a categorical variable that has values that are included in the change records of the enterprise change record universe. For example, the categorical variable may be the identity of a component vendor. In some embodiments, a non-categorical variable may be cast as a categorical variable for processing in process 1100. For example, a continuous variable may be expressed in “bins.” The bins then may be treated as categories. At step 1145, the system may determine whether the categorical variable has more than one value per change. If at step 1145, the system determines that the categorical variable does not have more than one value per change, process 1100 may continue at step 1146. At step 1146, the categorical variable may be used in the change records without transformation.

If at step 1145 the system determines that the categorical variable does have more than one value per change, process 1100 may continue at step 1147. At step 1147, the system may determine whether more than one of the multiple values is pertinent to failure prediction. If at step 1147 the system determines that not more than one of the values is pertinent to failure prediction, process 1100 may continue at step 1146 and proceed as described above.

If at step 1147 the system determines that more than one of the values is pertinent to failure prediction, process 1100 may continue at step 1148. At step 1148, the system may select values of the categorical variable (component vendor, e.g.) that occur in the change records with significant frequency. At step 1149, the system may create individual binary variables corresponding to the frequent values. For example, “Acme Components, Inc.” may occur frequently in the change records. The system would thus create the binary variable “ACME COMPONENTS.” At step 1150, the system may record for each change record a binary value for each of the binary variables. For example, in change record 345987, the binary variable ACME COMPONENTS would be TRUE if a change element in change record 345987 was associated with the vendor Acme Components, Inc. At step 1160 the system may write the binary variables and values to the change records.

FIG. 12 shows illustrative process 1200 for the modification of derived variables based on date and time attributes for the change. Steps 1261 through 1264 show the modification of derived variables based on date and time attributes for the change. At step 1261, data related to planned start time, planned end time and completion time for each change is retrieved. At step 1262, the planned duration of the change is calculated by subtracting the planned end data from the planned start data. At step 1263, new variables are created to indicate the hour of day, day of week, and/or month of year of each change. At step 1264, the new variables are written into the change record.

FIG. 13 shows illustrative process 1300 for collapsing multi-valued variables into variables having a reduced number of values. Process 1300 may correspond to procedure step 404 of process 400 (shown in FIG. 4).

At step 1301, the system may identify a variable that has, in at least one change record in the enterprise universe, more than one valid value. At step 1302, the system or a user may select consolidation method.

If at step 1302 it is decided that indicator variables are to be created, process 1300 may bridge to process 1100, step 1147 (shown in FIG. 11 and described above).

If at step 1302, the “greatest risk” approach is selected, process 1300 may continue at step 1309. At step 1309, the system may determine whether the variable to be collapsed is a categorical variable or an interval variable. Categorical variables have discrete values, while interval variables have continuous values.

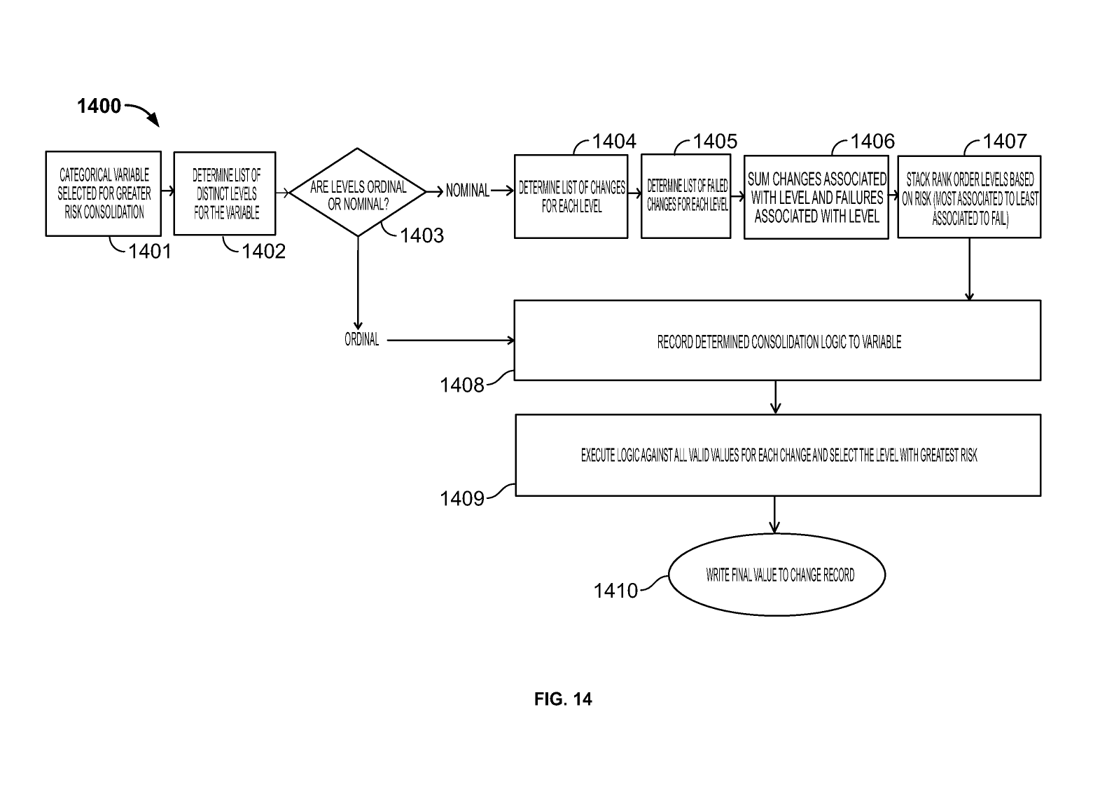

If at step 1309 the system determines that the variable is a categorical variable, process 1300 may continue bridge to process 1400, step 1402 (shown in FIG. 14).

If at step 1309 the system determines that the variable is an interval variable, process 1300 may continue at step 1312. At step 1312, the system may regress the variable against corresponding success/failure scores over all the change records in the enterprise change record universe to calculate a correlation relationship. At step 1313, the system may determine whether the correlation relationship is positive (increasing value for increasing failure risk, e.g.) or negative (decreasing value for increasing failure risk, e.g.).

At step 1314, the system may associate the correlation relationship with the variable. At step 1315, the system may apply the correlation relationship to values of the variable in each change record to produce a corresponding effective failure risk score for each of the values. The system may then select the greatest of the effective failure risk scores. At step 1316, the system may, in each record having multiple values of the variable, replace the multiple values with the greatest value.

If at step 1302, the “summation” approach is selected, process 1300 may continue at step 1317. At step 1317, the system may sum all valid values for the variable that are mapped to the change. The sum then becomes a new variable. For example, when the variable is “number of error messages generated per month,” the system may sum the number of error messages generated per month for all devices that map to a change. The system then designates the sum as a variable for the change record for the change. The system may process corresponding values of “number of error messages generated per month” in the other change records in the enterprise universe in the same manner. At step 1318, the system may write the sum into the change record.

If at step 1302, the “consolidation” approach is selected, process 1300 may continue at step 1319. At step 1319, the system or a user may designate one or more critical values to be compared to values in change records. For example, individual change records in the enterprise change record universe may include numerous hard disc models and numerous hard disc driver versions that map to the change represented by the change record. The system may designate hard disc model XYZ-1234 and driver version 100.3 as critical values, based on known incompatibilities with each other, for example.

At step 1320, the system may apply “AND” logic to the critical values with respect to each change record in the enterprise change record universe. At step 1321, when both the hard disc and driver are present in the change record, the system may set a Boolean variable to “TRUE.” At step 1322, when the change record does not include both the hard disc and the driver, the system may set the Boolean variable to “FALSE.” At step 1316, the system may write the Boolean variable and its value to the change record.

At step 1319, the system may designate one of the hard disc model and the driver version as critical values, for example, based on knowledge that the disc model and the driver version are prone to fail independently of each other. At step 1322, the system may apply “OR” logic to the critical values with respect to each change record in the enterprise change record universe. At step 1325, when either the hard disc or the driver are present in the change record, the system may set a Boolean variable to “TRUE.” At step 1326, when the change record does not include either of the hard disc and the driver, the system may set the Boolean variable to “FALSE.” At step 1316, the system may write the Boolean variable and its value to the change record.

FIG. 14 shows illustrative process 1400 for collapsing multiple values of categorical variables. The system may rank the values in order of failure risk, so that the value with the greatest risk may be selected.

At step 1401, the system may select a categorical variable for greatest risk consolidation. At step 1402, the system may generate a list of the distinct levels for the variable that occur in the enterprise change record universe. At step 1403, the system may determine whether the values are nominal or ordinal.

Ordinal levels are relative to each other and may be categorized based on failure risk by a simple relationship that indicates whether failure risk increases or decreases with order. If at step 1403 the system determines that the values are ordinal, process 1400 may continue at step 1408. At step 1408, the system may associate the relationship between order and failure risk with the variable. At step 1409, the system may apply the relationship to the ordinal values in each change record. The system may then select the level with the greatest failure risk. At step 1410, the system may write the value having the greatest risk, along with the failure risk, to the change record.

If at step 1403 the system determines that the values are nominal, process 1400 may continue at step 1404. At step 1404, the system may identify all of the failed changes in the enterprise change record universe that correspond to each nominal level. At step 1406, the system may sum all of the changes in the enterprise change record universe that correspond to each of the nominal levels. At step 1407, the system may rank the nominal levels based on the ratio of failed changes to total changes for each level. At step 1408, the ranking may be associated with the nominal variable. At step 1409, the ranking may be applied to each individual change record. Process 1400 may continue at step 1410, which is described above.

In some embodiments, the apparatus and methods may predict the likely impact of a failure of a change. Historical information about the extensiveness of failures that are associated with infrastructure changes may be used to predict the extensiveness of failures that may be associated with future infrastructure changes. The likelihood that a change will result in a failure (the “index,” as described above) and an estimated extensiveness of the failure (the “predicted failure magnitude”) may be combined to provide an “expected failure impact.” The processor may be configured to provide the predicted failure magnitude.

The predicted failure magnitude may correspond to the extensiveness of a predicted failure for an infrastructure change. The predicted failure magnitude may be based on the infrastructure change identifier, the device identifier and the application identifier. In some embodiments, the predicted failure magnitude may correspond to the number of interactions between customer and the infrastructure that fail. Each failed interaction may be considered a “failed customer interaction (‘FCI’).”

In online banking, for example, each time a customer logs on to the customer's online banking account, the customer has an interaction with the online banking infrastructure. If the infrastructure is unable to perform in the interaction, or performs below a standard of performance, the infrastructure is in failure and the interaction may be considered a failed customer interaction.

The predicted failure magnitude may be based on a number of failed customer interactions for some or all customers. The predicted failure magnitude may be a measurement, an estimate, a prediction, an index or any other suitable quantity, whether estimated, predicted, measured, observed, modeled or approximated.

The processor may be configured to provide an expected failure impact that corresponds to the change. The expected failure impact may be a prediction of possible consequences of the predicted failure. The expected failure impact may be based on the index and the predicted failure magnitude. In some embodiments, the expected failure impact may be based on the product of the index and the predicted failure magnitude. In some embodiments, the expected failure impact may be proportional to the product of the index and the predicted failure magnitude. In some embodiments, the expected failure impact may be the product of the index and the predicted failure magnitude.

Equation 1 shows a possible way in which expected failure impact depends on the index and the predicted failure magnitude for a given predicted failure.

Expected failure impact=index×predicted failure magnitude Eqn. 1

In some embodiments, the predicted failure magnitude may be calculated based on historical outcomes of change failures. One example of a historical outcome of a change failure is a historical failure magnitude. The historical failure magnitude may be quantified as shown in Equation 2.

historical failure magnitude=historical customer transaction rate×historical failure duration Eqn. 2

The historical transaction rate may correspond to a rate at which customers initiate transactions using the infrastructure. The historical failure duration may correspond to a length of time that the infrastructure is in failure. Historical failure magnitudes may be associated with a change by storing the historical failure magnitude in the change record. The models may then be used for forward prediction of failure magnitudes for future changes. The predicted failure magnitude may thus be produced by the predictive model.

In some embodiments, the historical customer transaction rate may be a time-averaged transaction rate. In some embodiments, the historical customer transaction rate may be estimated based on a temporal trend, a customer transaction rate at a point in time before the historical failure occurred or by any suitable estimation, approximation or modeling method.

Processes in accordance with the principles of the invention may include one or more features of the process illustrated in the following figures. For the sake of illustration, the steps of the processes illustrated in the FIGS. will be described as being performed by a “system”. The “system” may include one or more of the features of the apparatus that are shown in FIG. 3 and/or any other suitable device or approach. The “system” may be provided by an entity. The entity may be an individual, an organization or any other suitable entity, such as the enterprise.

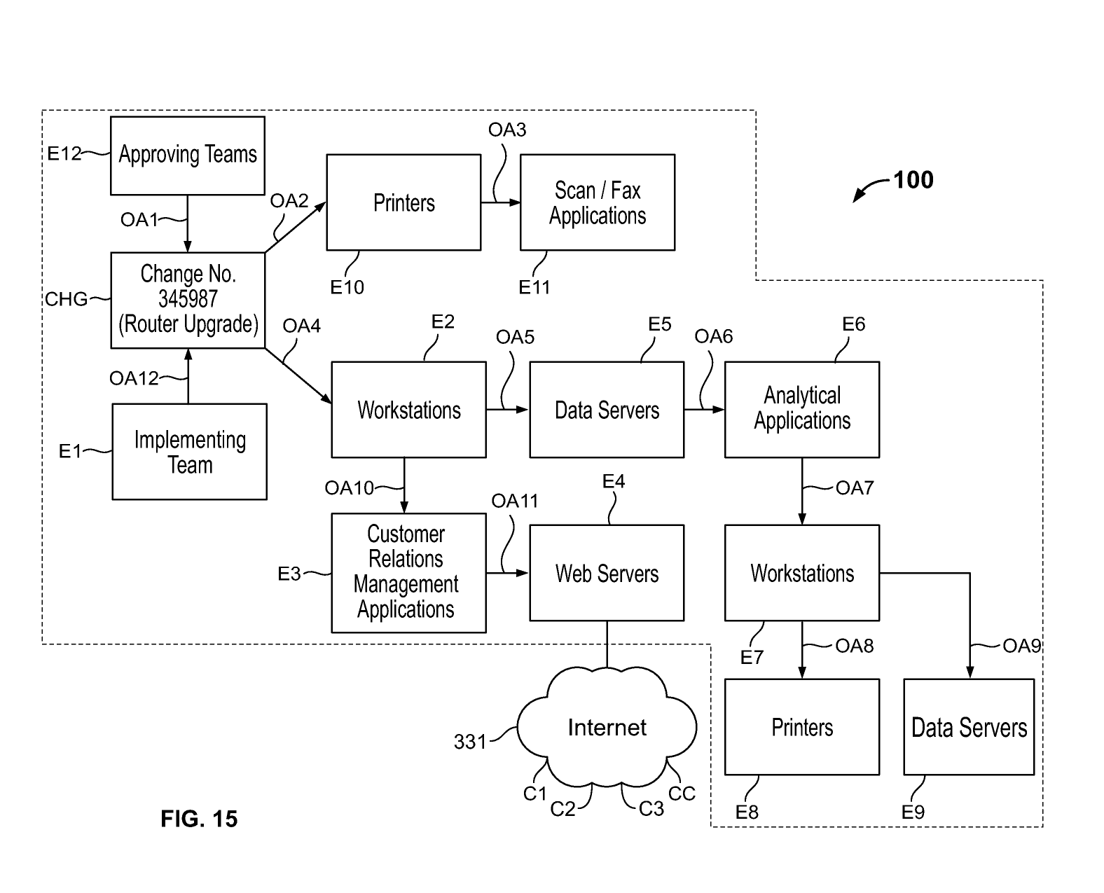

FIG. 15 shows change map 100 (initially shown in FIG. 1) along with Internet 331 (initially shown in FIG. 3) and customer clients C₁, C₂, C₃, . . . , Cᵢ. Each of customer clients Cᵢ may engage in a transaction with infrastructure shown in change map 100. Customer relations management applications E3 may include any suitable customer relations management applications, any suitable customer facing applications and any other suitable applications. The customer facing applications may include, for example, online banking applications, purchasing instrument (e.g., credit card, debit card, an instrument or device that includes a contactless chip, such as an IS014443-compliant contactless chip, or any other electronic purchasing device or virtual purchasing instrument) authentication and authorization applications or any other suitable customer facing applications. In some embodiments, the infrastructure may include automatic teller machines. In those embodiments, customers such as Cᵢ may interact with automated teller machines.

A failure may occur in any or all of the transactions between the infrastructure and customer clients Cᵢ. If a failure has a duration that last for a period of time, there may be one, some or many transactions with the Cᵢ customer clients that fail. During the duration, each of the Cᵢ customer clients may be involved in no attempted transactions, some attempted transactions or many attempted transactions. One or more attempted, partially or wholly failed, aborted or otherwise deficient transactions may be included in the calculation of the historical failure magnitude.

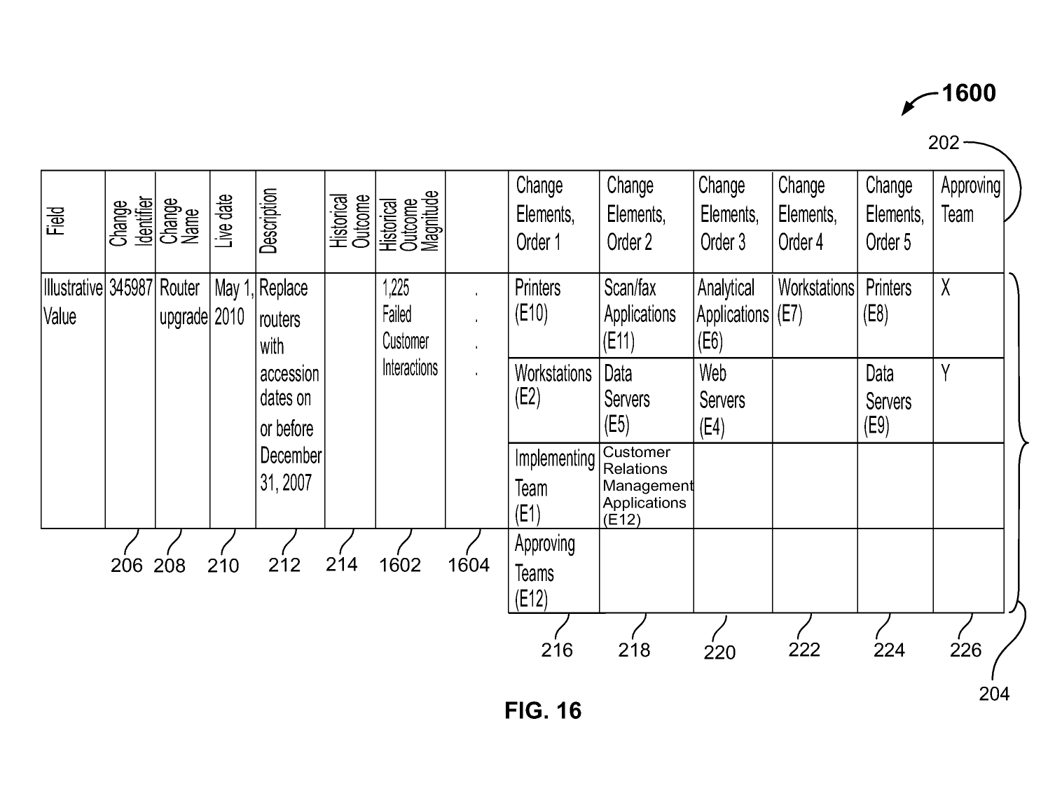

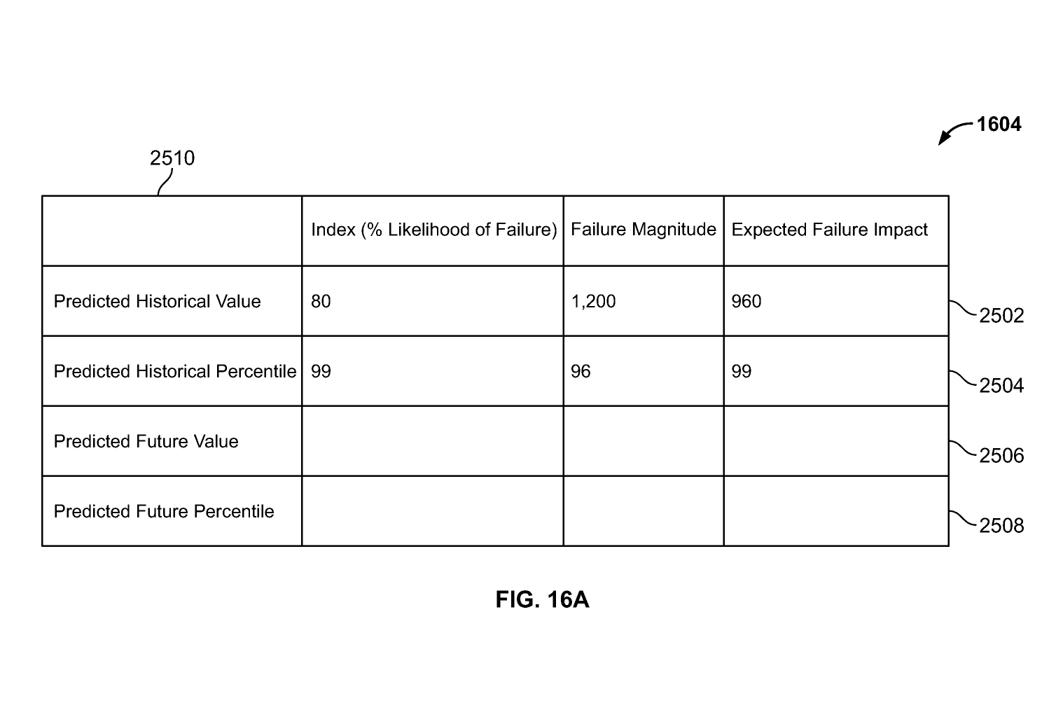

FIG. 16 shows illustrative change record 1600. Change record 1600 may include one or more of fields 202 that are present in change record 200 (shown in FIG. 2). Change record 1600 may include value 1602. Value 1602 may be a number (e.g., 1,225, as shown in FIG. 16) of failed customer interactions that are associated with change 345987. Change record 1600 may include modeled values 1604. Modeled values 1604 are shown in more detail in FIG. 16A.

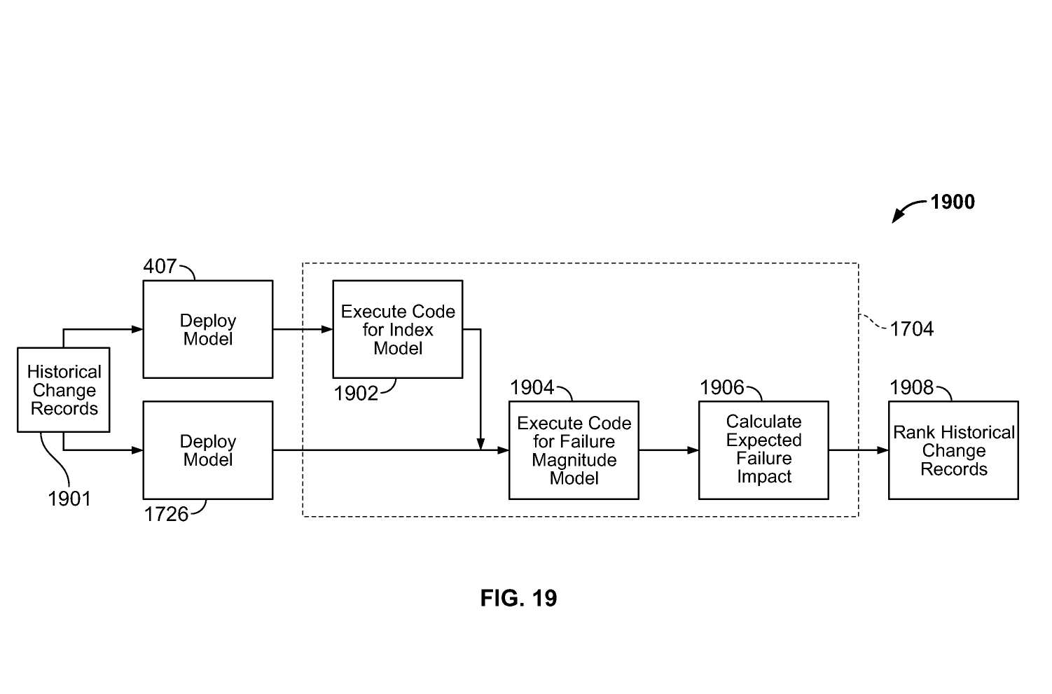

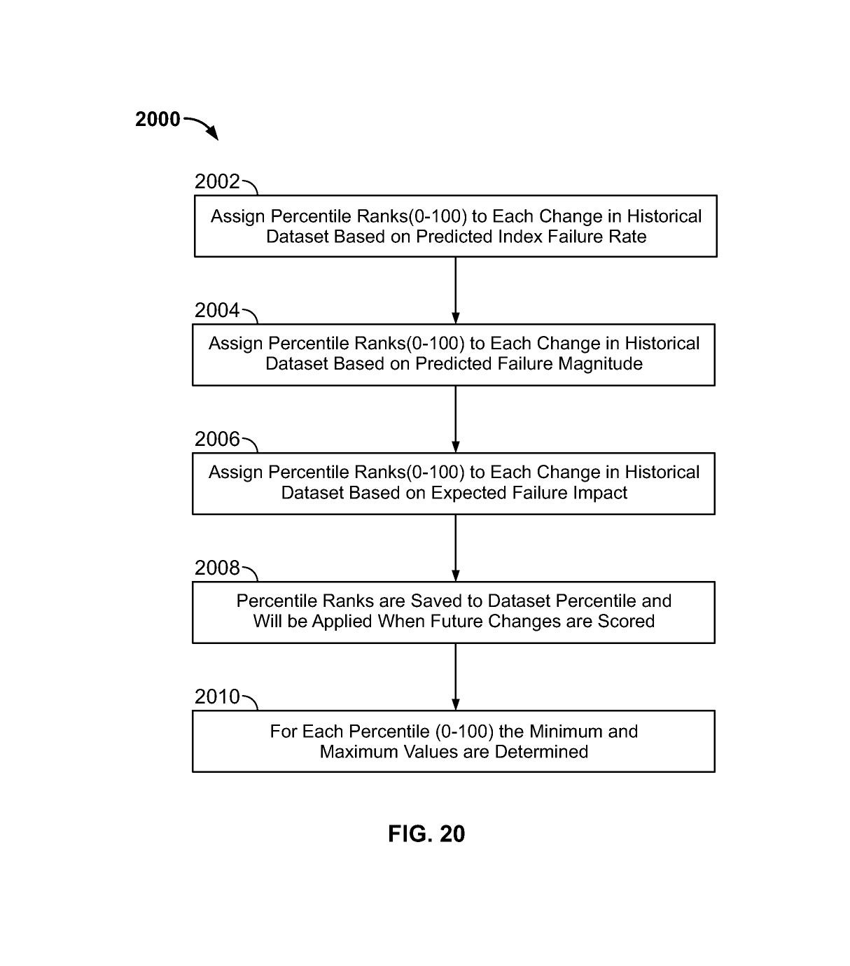

FIG. 16A shows modeled values 1604. Modeled values 1604 may include rows 2502, 2504, 2506 and 2508. Each of the rows includes values for a modeled index, a modeled failure magnitude and a modeled expected failure impact. Column 2510 identifies the nature of the modeled value. For example, row 2502 may include hypothetical historical modeled values of index (80% likelihood of failure), failure magnitude (1,200 failed customer interactions) and expected failure impact (960, equal to the product of the index and the failed customer interactions). The values in row 2502 may be generated by applying a predictive model to historical change records. For example, the values may be generated by applying a predictive model to historic change records as shown and described below in connection with process 1900 (shown in FIG. 19). Row 2504 may include percentiles corresponding to the index, failure magnitude and expected failure impact of row 2502. The percentiles in row 2504 may correspond to those shown and described in connection with process 2000 (shown in FIG. 20).

Modeled values 1604 correspond to change record 1600 at a hypothetical time in which predicted historical values and percentiles, in rows 2502 and 2504, respectively, have been calculated and stored in change record 1600. At such time, predicted future values and corresponding percentiles, in rows 2506 and 2508, respectively, have not yet been calculated. Rows 2506 and 2508 may be provided in change record 1600 to store the predicted future values and corresponding percentiles when they subsequently are calculated.

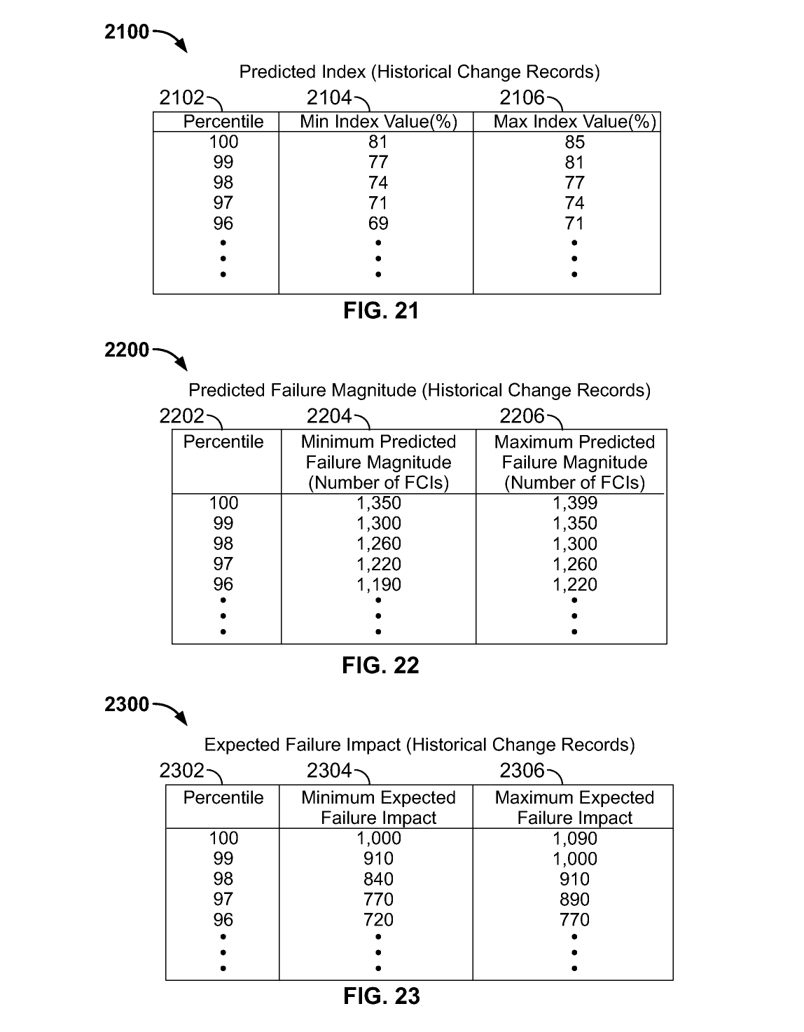

Row 2506 may be provided for storing predicted future values of index, failure magnitude and expected failure impact for a change record that corresponds to a future change. Corresponding percentiles may be calculated, as shown and described in connection with values 2100 (shown in FIG. 21), 2200 (shown in FIG. 22) and 2300 (shown in FIG. 23), and stored in row 2508.

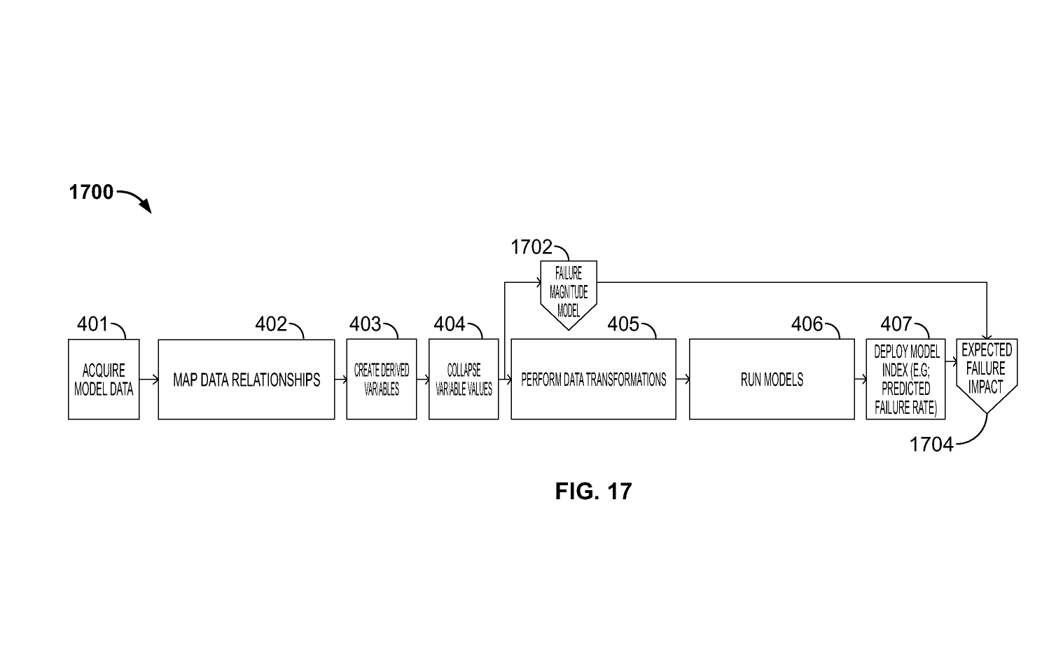

FIG. 17 shows illustrative process 1700. Process 1700 has steps 401-407 in common with process 400 (shown in FIG. 4). As discussed above, steps 401-407 may be used to deploy a model for predicting the index, which may be a predicted failure rate, for an infrastructure change. After collapse of variable values in step 404, process 1700 may proceed to step 405, at which data transformations are performed for index prediction. After collapse of variable values in step 404, process 1700 may proceed also to step 1702. At step 1702, failure magnitude modeling may begin. The system may perform step 1702 in parallel with steps 405, 406 and 407. In some embodiments, the system may distribute the processing of steps 1702, 405, 406 and 407 among different physical resources. In some embodiments, the system may save preliminary results from one or more of steps 1702, 405, 406 and 407 and, while storing the results, use resources to process others of the steps.

Step 1702 may include deploying a model for predicting failure magnitude for each change. Step 407 may include deploying a model for predicting the index for each change. At step 1704, the system may produce an expected failure impact for each change based on the failure magnitude and index models.

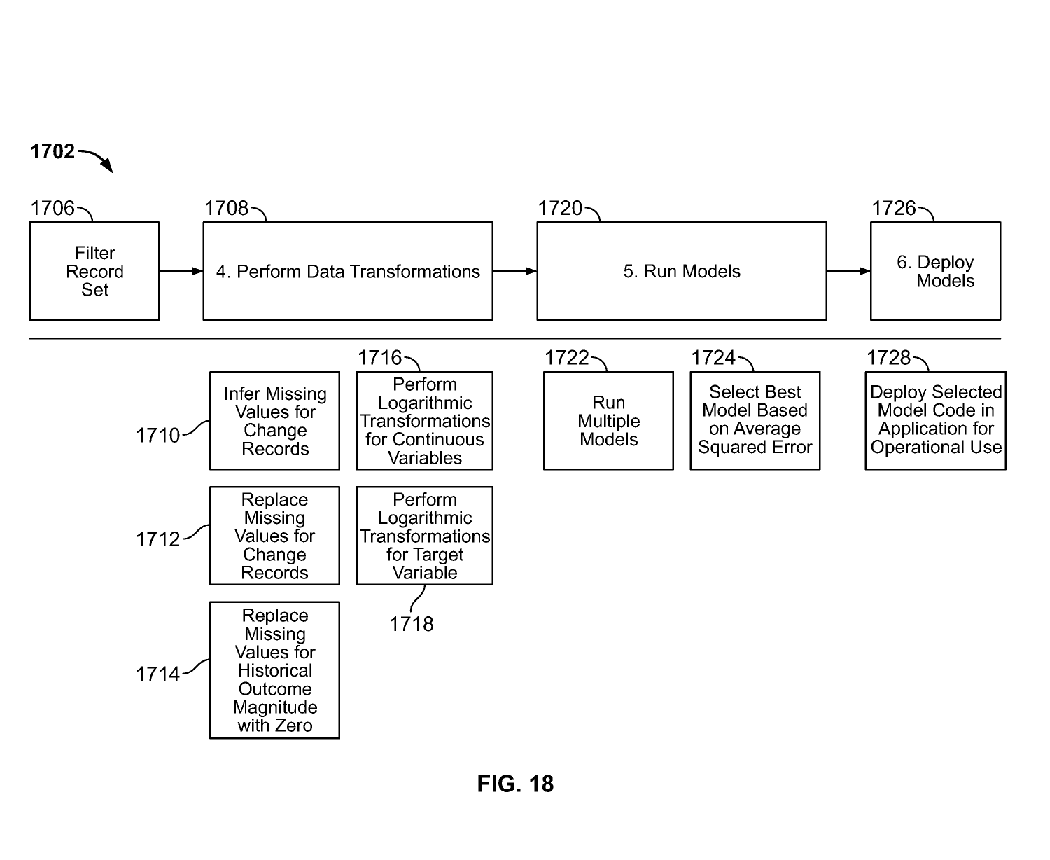

FIG. 18 shows illustrative details of process 1702 (shown in FIG. 17). At step 1706, the system may filter change records. The system may create a “second universe” of change records. The second universe of change records may include only change records that correspond to changes having a historical outcome that is a failure. In some embodiments, the system may flag change records that correspond to successful changes, create a second physical universe and remove successful changes or use any other suitable filtering approach.

In some embodiments, the second universe may include only those change records corresponding to changes in which at least a production incident, but not necessarily a failed customer interaction, occurred. In step 1702, the system may thus remove from analysis change records for successful changes.

The system may have access to enterprise records of changes and failed customer interactions that are associated physically, logically, operationally, or in any other suitable manner, with the changes. A failed customer interaction may be associated with one or more changes. A change, after successful changes are removed, may be associated with no failed customer interactions (in instances in which only a production incident occurred), one failed customer interaction or many failed customer interactions. When two or more changes are both linked to the same set of failed customer interactions, the failed customer interactions may be apportioned in any suitable way, among the changes. For example, the failed customer interactions may be divided evenly among the changes.

The number of failed customer interactions associated with each change may be recorded in the change record in historical outcome magnitude field 1602 (shown in FIG. 16).

At step 1708, the system may perform data transformations. Illustrative data transformations may include, where a change record is missing numerical data values, inference 1710 of the data values. Statistical or logical models, such as regression or neural networks, may require that every change record include values in every field. The system may therefore infer missing values using any suitable methods, such as individual decision trees, application of an expected value (mean), or selection of an appropriate constant.

The illustrative data transformations may include, where a change record is missing a categorical data value, replacement 1712 of the missing data value by categorical a value (“level”) that may be specified by a modeler or may be selected using any other suitable approach.

When a change resulted in the occurrence of a production incident that did not lead to a failed customer interaction, the processor may place a null value in historical outcome magnitude field 1602 (shown in FIG. 16). The illustrative data transformations may include replacement 1714 of the null value by a zero.

In the second universe of change records, fields in the change records that have values that vary over large ranges or are skewed may be scaled logarithmically. In some instances, the system may apply logarithmic scaling. The logarithmic scaling may reduce the effect of large variations on predictive model results. The system may apply the logarithmic scaling to one or more of numerically varying fields, continuously valued fields (1716), historical outcome magnitude field 1718 (1602, shown in FIG. 16) and any other suitable field.

At step 1720, the workbench may be used to develop one or more models to predict failure magnitude. The models may be trained using historical outcome magnitude field 1602 (shown in FIG. 16). The models may be based on any suitable analytical approach. The analytical approaches may include, for example, clustering and self-organizing maps, market basket analysis, sequence and web path analysis, linear and logistic regression, decision trees, gradient boosting, neural networks, least squares regression, multi-stage modeling and other suitable approaches. In some embodiments, the analytical approaches may include dimension reduction techniques such as, e.g., variable selection, LARS (Least Angle Regression) variable selection, principal components, variable clustering, time series analysis and other suitable dimension reduction techniques.

Predictive models may be tested (1722) using historical outcome magnitude. The models may be run using the workbench and may be based on regression (stepwise, backward, etc.), neural networks and decision trees or other suitable methods. Each model's settings may be iteratively tuned to improve performance.

In some embodiments, a suite of predictive models may be run against a set of historical changes (representing, for example, approximately 1 year of infrastructure change data). A model may then be selected (1724) based on any suitable subjective or objective criterion or criteria. For example, the criterion or criteria may be based on validation average squared error, or other suitable statistics.

At step 1726, a selected model may be deployed to predict failure magnitude of a prospective infrastructure change. The model can be deployed with code 1728 that receives as input a prospective change record. The code may include instructions for executing steps such as 401, 402, 403, 404, 1706 and 1708.

In some embodiments, the selected model may be executed on a periodic basis, or from time to time, on prospective infrastructure change records. The system may add to each prospective change record a predicted failure magnitude. Multiple prospective changes may be stacked ranked based on predicted failure magnitude from highest to lowest predicted failure magnitude. The highest predicted failure magnitude changes may be sent to an operations team that actively engages the appropriate implementation team or teams to address the predicted failure magnitudes identified.

FIG. 19 shows illustrative process 1900 for ranking expected failure impact for historical change records 1901. At step 1902, the system may execute the index modeling code that was deployed in step 407 (shown in FIG. 4) over historical change records 1901. At step 1904, the system may execute the failure magnitude modeling code that was deployed in step 407 (shown in FIG. 4) over historical change records 1901.

In some embodiments, the system may execute code that can be run on historical change records 1901 using either historical outcome 214 (shown in FIG. 2) or historical outcome magnitude 1602 (shown in FIG. 16) as a predicted (or “target”) variable of historical change records 1901. In those embodiments the system may be “set” to use one or the other of historical outcome 214 and historical outcome magnitude 1602 as the predicted variable.

In some embodiments, the system may execute two instances of the code, one instance using historical outcome 214 as the predicted variable and the other using historical outcome magnitude 1602 as the predicted variable. The system may first execute the code using historical outcome 214 as the predicted variable, save the resulting index for each change record, and then execute the code using historical outcome magnitude 1602 as the predicted variable. The system may first execute the code using historical outcome magnitude 1602 as the predicted variable, save the resulting index for each change record, and then execute the code using historical outcome 214 as the predicted variable. In this manner, each change record may be associated with a predicted historical outcome 214 and a predicted historical outcome magnitude 1602.

In step 1904, in some embodiments, the system may use a logarithmic transform, such as log₁₀, of historical outcome magnitude as the predicted variable. The system thus may predict the log of historical outcome magnitude for the historical data. The system may calculate and store the inverse log (that is, 10^{(log(historical outcome magnitude))}) of log(historical outcome magnitude) for each change record.

At step 1906, the system may calculate for each change record an expected failure impact for historical change records. The expected failure impact is calculated as set forth in Equation 1, when index and predicted failure magnitude are taken, for each change record, from steps 1902 and 1904, respectively.

At step 1908, the system may rank the historical change records. In some embodiments, in step 1908, the system may rank only the change records in the second universe of change records. The change records may be ranked by one or more of the index, the predicted failure magnitude and the expected failure impact. The change records may be ranked by absolute value, scaled value, percentile or any other suitable metric.

FIG. 20 shows illustrative process 2000 for ranking the historical change records. At step 2002, the system may assign to each historical change record an index (failure rate) percentile (0-100) based on an overall statistical distribution of the index values in the historical change records. At step 2004, the system may assign to each historical change record a predicted failure magnitude percentile (0-100) based on an overall statistical distribution of the predicted failure magnitude values in the historical change records. At step 2006, the system may assign to each historical change record an expected failure impact percentile (0-100) based on an overall statistical distribution of the expected failure impact values in the historical change records. At step 2008, the percentiles from one or more of steps 2002, 2004 and 2006 may be saved.

At step 2010, minimum and maximum values for one or more of the percentiles for each of the index, the predicted failure magnitude and the expected failure impact may be calculated. The minimum and maximum values may be used to characterize one or more predicted index, predicted failure magnitudes and expected failure impact for a change record that corresponds to a future change.

FIG. 21 shows illustrative values 2100 of percentiles (2102) and corresponding minimum (2104) and maximum values (2106) for predicted indices for historical change records.

FIG. 22 shows illustrative values 2200 of percentiles (2202) and corresponding minimum (2204) and maximum values (2206) for predicted indices for historical change records.

FIG. 23 shows illustrative values 2300 of percentiles (2302) and corresponding minimum (2304) and maximum values (2306) for predicted indices for historical change records.

Minimum values 2104, 2204 and 2304 along with corresponding maximum values 2106, 2206 and 2306 can be used to identify corresponding percentiles for a predicted index, a predicted failure magnitude and an expected failure impact that are based on a future change record.

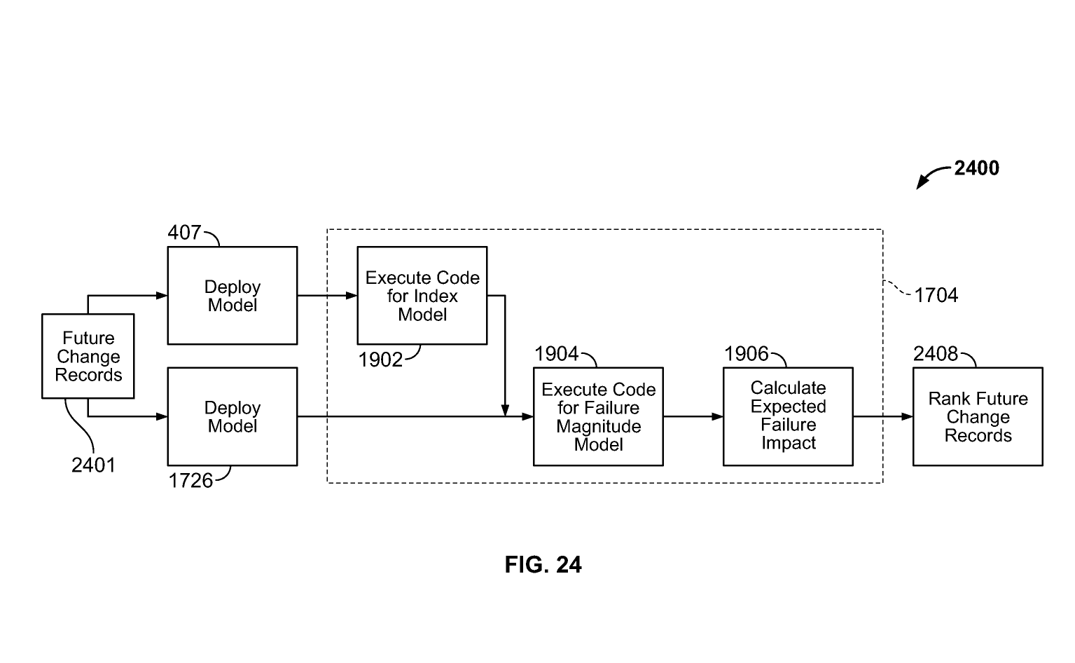

FIG. 24 shows illustrative process 2400 for ranking future change records. Process 2400 has in common with process 1900 one or more of the following steps: 407, 1726, 1902, 1904 and 1906 (all shown in FIG. 19). In process 2400, future change records 2401 are input into steps 407 and 1726. The system may use process 1704 to produce expected failure impact values for future change records 2401. At step 2408, the system may rank future change records 2401 based on percentiles that were established in step 1908 (shown in FIG. 19). For example, the system may use a lookup table based on values 2100, 2200 and 2300 to identify percentiles for the indices, predicted failure magnitudes and expected failure impacts, respectively, of future change records 2104.

The enterprise may allocate resources to mitigate risk of future changes based on one or more of highest ranking change records with respect to index, predicted failure magnitude and expected failure impact.

Thus, apparatus and methods for reducing infrastructure failure rates are therefore provided. Persons skilled in the art will appreciate that the present invention can be practiced by other than the described embodiments, which are presented for purposes of illustration rather than of limitation, and that the present invention is limited only by the claims that follow.

What is claimed is:

1. Apparatus for reducing infrastructure failure rates, the apparatus comprising:
machine readable memory configured to store a data object that includes:
an infrastructure change identifier that identifies an infrastructure change;
a device identifier that identifies a device that is associated with the change; and
an application identifier that identifies a program that is associated with the change; and
a processor that is configured to provide:
an index that is based on the infrastructure change identifier, the device identifier and the application identifier, the index corresponding to a predicted failure rate; and
a predicted failure magnitude that is based on the infrastructure change identifier, the device identifier and the application identifier;
wherein:
the index corresponds to a predicted failure rate; and
the predicted failure magnitude corresponds to a predicted failure magnitude.

2. The apparatus of claim 1 wherein the data object stored in machine readable memory further includes an approver identifier that identifies an approving organization associated with the change.

3. The apparatus of claim 1 wherein the data object stored in machine readable memory further includes a team identifier that identifies an implementing team associated with the change.

4. The apparatus of claim 1 wherein:
the device and the program are, respectively, first and second elements of a plurality of elements, each element having (a) an operational association with the infrastructure change and (b) an element identifier; and
the processor is configured to include in the data object the element identifiers.

5. The apparatus of claim 4 wherein the data object further includes the operational associations of the elements.

6. The apparatus of claim 1 wherein the processor is further configured to provide an expected failure impact that corresponds to the change and is based on the product of the index and the predicted failure magnitude.

7. The apparatus of claim 6 wherein the expected failure impact is proportional to the product.

8. The apparatus of claim 6 wherein the predicted failure magnitude is based on the product of a transaction rate and a failure duration, the transaction rate corresponding to a rate at which customers initiate transactions using the infrastructure, the failure duration corresponding to a length of time that the infrastructure is in failure.

9. One or more computer-readable media storing computer-executable instructions which, when executed by a processor on a computer system, perform a method for reducing technology failure rates, the method comprising:
storing in machine readable memory:
an infrastructure change identifier that identifies a technology change;
a device identifier that identifies a device that is associated with the change; and
an application identifier that identifies a program that is associated with the change; and
providing, using a processor:
an index that is based on the technology change identifier, the device identifier and the application identifier, the index corresponding to a predicted failure rate; and
a predicted failure magnitude that is based on the technology change identifier, the device identifier and the application identifier;
wherein:
the index corresponds to a predicted failure rate; and
the predicted failure magnitude corresponds to a predicted failure magnitude.

10. The media of claim 9 wherein, in the method, the storing includes storing an approver identifier that identifies an approving organization associated with the change.

11. The media of claim 9 wherein, in the method, the storing includes storing a team identifier that identifies an implementing team associated with the change.

12. The media of claim 9 wherein, in the method:
the device and the program are, respectively, first and second elements of a plurality of elements, each element having (a) an operational association with the technology change and (b) an element identifier; and
the storing includes storing the element identifiers.

13. The media of claim 12 wherein, in the method, the storing further includes storing the operational associations of the elements.

14. The media of claim 9 wherein, in the method, the processing further includes providing an expected failure impact that corresponds to the change and is based on the product of the index and the predicted failure magnitude.

15. The media of claim 14 wherein, in the method, the expected failure impact is proportional to the product.

16. The media of claim 14 wherein, in the method, the predicted failure magnitude is based on the product of a transaction rate and a failure duration, the transaction rate corresponding to a rate at which customers initiate transactions using the technology, the failure duration corresponding to a length of time that the infrastructure is in failure.

17. A method for reducing technology failure rates, the method comprising:
storing in machine readable memory:
an infrastructure change identifier that identifies a technology change;
a device identifier that identifies a device that is associated with the change; and
an application identifier that identifies a program that is associated with the change; and
providing, using a processor:
an index that is based on the technology change identifier, the device identifier and the application identifier, the index corresponding to a predicted failure rate; and
a predicted failure magnitude that is based on the technology change identifier, the device identifier and the application identifier;
wherein:
the index corresponds to a predicted failure rate; and
the predicted failure magnitude corresponds to a predicted failure magnitude.

18. The method of claim 17 wherein the storing includes storing an approver identifier that identifies an approving organization associated with the change.

19. The method of claim 17 wherein the storing includes storing a team identifier that identifies an implementing team associated with the change.

20. The method of claim 17 wherein:
the device and the program are, respectively, first and second elements of a plurality of elements, each element having (a) an operational association with the technology change and (b) an element identifier; and
the storing includes storing the element identifiers.

21. The method of claim 20 wherein the storing further includes storing the operational associations of the elements.

22. The method of claim 17 wherein the processing further includes providing an expected failure impact that corresponds to the change and is based on the product of the index and the predicted failure magnitude.

23. The method of claim 22 wherein the expected failure impact is proportional to the product.

24. The method of claim 22 wherein the predicted failure magnitude is based on the product of a transaction rate and a failure duration, the transaction rate corresponding to a rate at which customers initiate transactions using the technology, the failure duration corresponding to a length of time that the infrastructure is in failure.
